(19) United States
(12) Patent Application Publication
(10) Pub. No.: US 2025/0052927 A1
(43) Pub. Date: Feb. 13, 2025

(54) UV/HEVL-FILTERING SILICONE HYDROGEL CONTACT LENSES

(71) Applicant: Alcon Inc., Fribourg (CH)

(72) Inventors: Ya-Wen Chang, Alpharetta, GA (US); Steve Yun Zhang, Sugar Hill, GA (US)

(21) Appl. No.: 18/795,402

(22) Filed: Aug. 6, 2024

Related U.S. Application Data
(60) Provisional application No. 63/517,997, filed on Aug. 7, 2023.

(51) Int. Cl. G02B 1/04; B29D 11/00; C08L 83/04; C09B 69/10; G02C 7/04; G02C 7/10

(52) U.S. Cl. CPC G02B 1/043; B29D 11/00067; B29D 11/00134; B29D 11/00192; C08L 83/04; C09B 69/108; G02C 7/04; G02C 7/104; G02C 7/108

(57) ABSTRACT

Described herein is a UV/HEVL-filtering SiHy contact lens that not only has a relatively high UV/HEVL filtering capability but also has an aesthetic appealing color. The bulk silicone hydrogel of the UV/HEVL-filtering SiHy contact lens comprises repeating units of (1) at least one hydrophilic vinylic monomer, (2) at least one siloxane-containing vinylic monomer and/or at least one polysiloxane vinylic crosslinker, (3) at least one UV-absorbing vinylic monomer, and (4) a least one polymerizable HEVL-absorbing compound capable of absorbing HEVL between 380 nm and 450 nm and also comprises at least one blue-tinting agent and at least one optical brightener distributed therein.

This application claims the benefit under 35 USC § 119 (e) of U.S. provisional application No. 63/517,997 filed 7 Aug. 2023, herein incorporated by reference in its entirety.

This invention is related to a method for making contact lenses, preferably silicone hydrogel contact lenses, which can significantly filter UV lights and high-energy visible lights (HEVL) with wavelengths from 380 nm to 450 nm while having an aesthetic appealing color (i.e., minimizing an unappealingly yellow color). This invention is also related to UV/HEVL-filtering contact lenses produced according to a method of the invention.

### BACKGROUND

LED lights and electronic device, including smart phones, computer screens, LCD and LED televisions, have been extensively used. They typically can emit short wavelength visible light, including violet light (380-450 nm) and blue light (450-495 nm). Such short wavelength visible lights were shown to be damaging to cells both in in vitro and in vivo studies reported in Experimental Eye Research 2006, 83, 1493; J. Cataract Refrac Surg 2009, 35, 354; Graefe's Arch Clin Exp Ophthalmol 2008, 246, 671; Acta Ophthalmologica Scandinavica 2006, 84, 4; Br J Ophthalmol 2006, 90, 784; Optometry and Vision Science 2011, 88 (6), 1. A great effort has been made to develop HEVL-filtering ophthalmic lenses, such as, spectacles, contact lenses, intraocular lenses, etc. to protect eyes from increasing exposures of HEVL due to widely use of LED lights and LED displays, e.g., smart phone, TV and computer monitor (see, e.g., U.S. Pat. Nos. 4,612,358, 4,528,311, 4,716,234, 4,878,748, 5,400,175, 5,662,707, 6,158,862, 6,955,430, 7,556,376, 7,803,359, 8,153,703, 8,232,326, 8,360,574, 8,585,938, 8,882,267, 9,377,569, 9,683,102, 9,814,658, 10,551,637, and 10,610,472; U.S. Pat. Appl. Pub. Nos. 20170242274, 20180371139, 20190002415, 20190002459, 20190271798, 20190339544, 20200002267, 20200095187, 20200407324, and 20200407337).

TOTAL30® (from Alcon) is the first contact lens to offer HEVL-filtering capability that is constantly in effect while wearing the lenses regardless of the lighting conditions. TOTAL30® not only includes Class I UV absorption for protection against UVA and UVB rays (i.e., filtering more than 90% UVA and 99% UVB rays), but also can filter out approximately 33% of HEVL rays entering the eye (between 380-450 nm). Alcon subsequently launched a second product, TOTAL1@, which like TOTAL30® can block 90% UVA, 99% UVB, and 33% HEVL. Johnson & Johnson Vision Care recently also launched ACUVUE® OASYS MAX 1-DAY which can block up to 45% HEVL according to its published 510 (k) Premarket Notification (K210930).

It would still be desirable to have a contact lens product with HEVL-filtering capability much higher than currently available commercial contact lenses to better protect wears' eyes from HEVL damages, especially violet light damages. However, a higher HEVL-filtering capability typically requires increasing the amount of an HEVL absorber in a contact lens. An increasing in loading a HEVL absorber in a contact lens would negatively affect the aesthetic appearance of the contact lens, making it more unappealingly yellow. Although addition of a blue-tinting agent (e.g., Cu(II)-phthalocyanine pigments, a reactive blue dye RB246 or RB247, or the like) could offset yellow color of the contact lens to some degrees, it will still contribute to increased darkness of the contact lens.

Therefore, there is need for contact lenses, especially silicone hydrogel contact lens, capable of significantly filtering HEVL while minimizing the appearance of an unappealingly yellow color and such high HEVL-filtering contact lenses.

### SUMMARY OF THE INVENTION

The invention provides a UV/HEVL-filtering contact lens, comprising a bulk silicone hydrogel material that comprises: (1) repeating units of at least one hydrophilic vinylic monomer; (2) repeating units of at least one silicone-containing vinylic monomer and/or at least one polysiloxane vinylic crosslinker; (3) repeating units of at least one UV-absorbing vinylic monomer; (4) repeating units of at least one polymerizable HEVL-absorbing compound capable of absorbing HEVL between 380 nm and 450 nm; (5) at least one blue-tinting agent distributed within the bulk silicone hydrogel material; and (6) at least one optical brightener distributed within the bulk silicone hydrogel material in an amount for provide the HEVL-filtering contact lens in fully hydrated state with a reduced b* value without decreasing HEVL % T of the HEVL-filtering contact lens, wherein the HEVL-filtering contact lens in fully hydrated state has a UVA % T of less than 5%, UVB % T of about 1% or less, a HEVL % T of about 65% or less, and an averaged % transmission of at least 90% between 450 nm and 700 nm.

### BRIEF DESCRIPTIONS OF THE DRAWINGS

FIG. 1 shows the UV/visible transmission spectra of HEVL-filtering SiHy contact lenses (−3.0 D): Curve 1—Control (HEVL % T=59.3%); Curve 2—Extracted with 1-propanol (HEVL % T=57.1%); and Curve 3—extracted with deionized water (HEVL % T=51.8%).

### DETAILED DESCRIPTION OF THE INVENTION

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well known and commonly employed in the art.

“About” as used herein means that a number referred to as “about” comprises the recited number plus or minus 1-10% of that recited number.

“Optional” or “optionally” means that the subsequently described event or circumstance can or cannot occur, and that the description includes instances where the event or circumstance occurs and instances where it does not.

An “ophthalmic device”, as used herein, refers to a contact lens (hard or soft), an intraocular lens, a corneal onlay, other ophthalmic devices (e.g., stents, glaucoma shunt, or the like) used on or about the eye or ocular vicinity.

“Contact Lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens.

A “hydrogel contact lens” refers to a contact lens comprising a hydrogel bulk (core) material. A hydrogel bulk material can be a non-silicone hydrogel material or preferably a silicone hydrogel material.

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated).

A siloxane, which often also described as a silicone, refers to a molecule having at least one moiety of —Si—O—Si— where each Si atom carries two organic groups as substituents.

A “silicone hydrogel” or “SiHy” refers to a silicone-containing hydrogel obtained by copolymerization of a polymerizable composition comprising at least one silicone-containing monomer or at least one silicone-containing macromer or at least one crosslinkable silicone-containing prepolymer.

As used in this application, the term “non-silicone hydrogel” refers to a hydrogel that is theoretically free of silicon.

“Hydrophilic,” as used herein, describes a material or portion thereof that will more readily associate with water than with lipids.

The term “room temperature” refers to a temperature of about 22° C. to about 26° C.

The term “soluble”, in reference to a compound or material in a solvent, means that the compound or material can be dissolved in the solvent to give a solution with a concentration of at least about 0.5% by weight at room temperature (i.e., from about 22° C. to about 26° C.).

The term “insoluble”, in reference to a compound or material in a solvent, means that the compound or material can be dissolved in the solvent to give a solution with a concentration of less than 0.01% by weight at room temperature (as defined above).

A “vinylic monomer” refers to a compound that has one sole ethylenically unsaturated group, is soluble in a solvent, and can be polymerized actinically or thermally.

The term “ethylenically unsaturated group” is employed herein in a broad sense and is intended to encompass any groups containing at least one >C═CH₂ group. Exemplary ethylenically unsaturated groups include without limitation

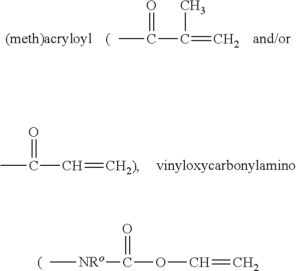

in which R^{o} is H or C₁-C₄ alkyl),

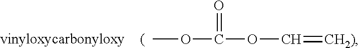

allyl, vinyl, styrenyl, or other C═C containing groups.

As used herein, “actinically” in reference to curing, crosslinking or polymerizing of a polymerizable composition, a prepolymer or a material means that the curing (e.g., crosslinked and/or polymerized) is performed by actinic irradiation, e.g., UV/visible light irradiation, or the like. Thermal curing or actinic curing methods are well-known to a person skilled in the art.

An “acrylic monomer” refers to a vinylic monomer having one sole (meth)acryloyl group. Examples of acrylic monomers includes (meth)acryloxy [or (meth)acryloyloxy] monomers and (meth)acrylamido monomers.

An “(meth)acryloxy monomer” or “(meth)acryloyloxy monomer” refers to a vinylic monomer having one sole group of

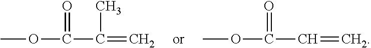

An “(meth)acrylamido monomer” refers to a vinylic monomer having one sole group of

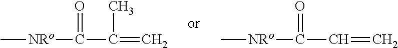

in which R^{o} is H or C₁-C₄ alkyl.

The term “(meth)acrylamide” refers to methacrylamide and/or acrylamide.

The term “(meth)acrylate” refers to methacrylate and/or acrylate.

An “N-vinyl amide monomer” refers to an amide compound having a vinyl group (—CH═CH₂) that is directly attached to the nitrogen atom of the amide group.

The term “ene group” refers to a monovalent radical of CH₂═CH— or CH₂═CCH₃— that is not covalently attached to an oxygen or nitrogen atom or a carbonyl group.

An “ene monomer” refers to a vinylic monomer having one sole ene group.

A “vinyloxycarbonylamino monomer” refers to a vinylic monomer having one sole vinyloxycarbonylamino group.

A “vinylaminocarbonyloxy monomer” refers to a vinylic monomer having one sole vinylaminocarbonyloxy group.

A “vinylaminocarbonylamino monomer” refers to a vinylic monomer having one sole vinylaminocarbonylamino group.

A “hydrophilic vinylic monomer” refers to a vinylic monomer which typically yields a homopolymer that is water-soluble or can absorb at least 10 percent by weight of water.

A “hydrophobic vinylic monomer” refers to a vinylic monomer which typically yields a homopolymer that is insoluble in water and can absorb less than 10% by weight of water.

As used in this application, the term “vinylic crosslinker” refers to an organic compound having at least two ethylenically unsaturated groups. A “vinylic crosslinking agent” refers to a vinylic crosslinker having a molecular weight of 700 Daltons or less.

An “acrylic crosslinker” refers to a vinylic crosslinker having at least two (meth)acryloyl groups.

The term “acrylic repeating units” refers to repeating units of a polymeric material, each of which is derived from an acrylic monomer or crosslinker in a free-radical polymerization to form the polymeric material.

The term “terminal (meth)acryloyl group” refers to one (meth)acryloyl group at one of the two ends of the main chain (or backbone) of an organic compound.

As used in this application, the term “polymer” means a material formed by polymerizing and/or crosslinking one or more monomers, macromers, prepolymers or combinations thereof.

A “macromer” or “prepolymer” refers to a compound or polymer that contains ethylenically unsaturated groups and has a number average molecular weight of >700 Daltons.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatography) with one or more of a refractive index detector, a low-angle laser light scattering detector, a multi-angle laser light scattering detector, a differential viscometry detector, a UV detector, and an infrared (IR) detector; MALDI-TOF MS (matrix-assisted laser desorption/ionization time-of-flight mass spectroscopy); 1H NMR (Proton nuclear magnetic resonance) spectroscopy, etc.

A “polysiloxane segment” or “polydiorganosiloxane segment” interchangeably refers to a polymer chain segment (i.e., a divalent radical) of

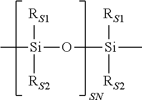

in which SN is an integer of 3 or larger and each of R_{S1} and R_{S2} independent of one another are selected from the group consisting of: C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₁₈ alkyl; -alk-(OC₂H₄)_{γ1}—OR^{o} (in which alk is C₁-C₆ alkylene diradical, R^{o} is H or C₁-C₄ alkyl and γ1 is an integer from 1 to 10); a C₂-C₄₀ organic radical having at least one functional group selected from the group consisting of hydroxyl group (—OH), carboxyl group (—COOH), amino group (—NR_{N1}R_{N1}′), amino linkages of —NR_{N1}—, amide linkages of —CONR_{N1}—, amide of —CONR_{N1}R_{N1}′, urethane linkages of —OCONH—, and C₁-C₄ alkoxy group, or a linear hydrophilic polymer chain, in which R_{N1} and R_{N1}′ independent of each other are hydrogen or a C₁-C₁₅ alkyl; and a photochromic organic radical having a photochromic group.

A “polydiorganosiloxane vinylic monomer” or “polysiloxane vinylic monomer” interchangeably refers to a compound comprising at least one polysiloxane segment and one sole ethylenically-unsaturated groups.

A “polydiorganosiloxane vinylic crosslinker” or “polysiloxane vinylic crosslinker” interchangeably refers to a compound comprising at least one polysiloxane segment and at least two ethylenically-unsaturated groups.

A “linear polydiorganosiloxane vinylic crosslinker” or “linear polysiloxane vinylic crosslinker” interchangeably refers to a compound comprising a main chain which includes at least one polysiloxane segment and is terminated with one ethylenically-unsaturated group at each of the two ends of the main chain.

A “chain-extended polydiorganosiloxane vinylic crosslinker” or “chain-extended polysiloxane vinylic crosslinker” interchangeably refers to a compound comprising at least two ethylenically-unsaturated groups and at least two polysiloxane segments each pair of which are linked by one divalent radical.

The term “fluid” as used herein indicates that a material is capable of flowing like a liquid.

As used in this application, the term “clear” in reference to a polymerizable composition means that the polymerizable composition is a transparent solution or liquid mixture having a light transmissibility of 85% or greater (preferably 90% or greater) between 400 to 700 nm.

A free radical initiator can be either a photoinitiator or a thermal initiator. A “photoinitiator” refers to a chemical that initiates free radical crosslinking/polymerizing reaction by the use of light. A “thermal initiator” or “thermal free radical initiator” interchangeably refers to a chemical that initiates free radical crosslinking/polymerizing reaction by heating.

The term “monovalent radical” refers to an organic radical that is obtained by removing a hydrogen atom from an organic compound and that forms one bond with one other group in an organic compound. Examples include without limitation, alkyl (by removal of a hydrogen atom from an alkane), alkoxy (or alkoxyl) (by removal of one hydrogen atom from the hydroxyl group of an alkyl alcohol), thiyl (by removal of one hydrogen atom from the thiol group of an alkylthiol), cycloalkyl (by removal of a hydrogen atom from a cycloalkane), cycloheteroalkyl (by removal of a hydrogen atom from a cycloheteroalkane), aryl (by removal of a hydrogen atom from an aromatic ring of the aromatic hydrocarbon), heteroaryl (by removal of a hydrogen atom from any ring atom), amino (by removal of one hydrogel atom from an amine), etc.

The term “divalent radical” refers to an organic radical that is obtained by removing two hydrogen atoms from an organic compound and that forms two bonds with other two groups in an organic compound. For example, an alkylene divalent radical (i.e., alkylenyl) is obtained by removal of two hydrogen atoms from an alkane, a cycloalkylene divalent radical (i.e., cycloalkylenyl) is obtained by removal of two hydrogen atoms from the cyclic ring.

In this application, the term “substituted” in reference to an alkyl or an alkylenyl means that the alkyl or the alkylenyl comprises at least one substituent which replaces one hydrogen atom of the alkyl or the alkylenyl and is selected from the group consisting of hydroxyl (—OH), carboxyl (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, and combinations thereof.

“Post-curing surface treatment”, in reference to a SiHy lens bulk material or a SiHy contact lens, means a surface treatment process that is performed after the SiHy lens bulk material or the SiHy contact lens is formed by curing (i.e., thermally or actinically polymerizing) a SiHy lens formulation.

The term “silicone hydrogel lens formulation” or “SiHy lens formulation” interchangeably refers to a polymerizable composition that comprises all necessary polymerizable components for producing a SiHy contact lens or a SiHy lens bulk material known to a skilled person.

A “UV-absorbing vinylic monomer” refers to a compound comprising one sole ethylenically-unsaturated group and can absorb predominantly UV lights between 280 nm to 380 nm. It is understood that a UV-absorbing vinylic monomer does not absorb or absorbs negligibly lights having a wavelength greater 400 nm (i.e., having a % T at 400 nm of greater than 90% when tested with a solution of the UV-absorbing vinylic monomer at a concentration of 0.1 mM and a path length of 1 cm).

A “HEVL-absorbing vinylic monomer” refers to a compound comprising one sole ethylenically-unsaturated group and can absorb HEVL between 380 nm and 450 nm. It is understood that a HEVL-absorbing vinyl monomer can also absorb UV lights between 280 nm and 380 nm.

“UVA” refers to radiation occurring at wavelengths between 315 and 380 nanometers; “UVB” refers to radiation occurring between 280 and 315 nanometers; “HEVL” refers to radiation occurring at wavelengths between 380 and 450 nanometers.

“UVA transmittance” (or “UVA % T”), “UVB transmittance” or “UVB % T”, and “HEVL-transmittance” or “HEVL % T” are calculated by the following formula.

UVA % T=Average % Transmission between 315 nm and 380 nm×100

UVB % T=Average % Transmission between 280 nm and 315 nm×100

HEVL % T=Average % Transmission between 380 nm and 450 nm×100

HEVL % filtration=100%−HEVL % T

“% T at a wavelength” refers to a percent transmission at the specified wavelength.

The “oxygen permeability”, Dkᵢ, of a material is the rate at which oxygen will pass through a material and can be measured at about 34-35° C. according to the procedures described in Example 1. Oxygen permeability is conventionally expressed in units of barrers, where “barer” is defined as [(cm³ oxygen)(mm)/(cm²)(sec)(mm Hg)]×10⁻¹⁰.

The “oxygen transmissibility”, Dk/t, of a lens or material is the rate at which oxygen will pass through a specific lens or material with an average thickness of t [in units of mm] over the area being measured. Oxygen transmissibility is conventionally expressed in units of barrers/mm, where “barrers/mm” is defined as [(cm³ oxygen)/(cm²)(sec)(mm Hg)]×10⁻⁹.

The term “modulus” or “elastic modulus” in reference to a contact lens or a material means the tensile modulus or Young's modulus which is a measure of the stiffness of a contact lens or a material. The modulus can be measured according to the procedures described in Example 1.

A “coating” in reference to a contact lens means that the contact lens has, on its surfaces, a thin layer of a material that is different from the bulk material of the contact lens and obtained by subjecting the contact lens to a surface treatment.

“Surface modification” or “surface treatment”, as used herein, means that an article has been treated in a surface treatment process, in which (1) a coating is applied to the surface of the article, (2) chemical species are adsorbed onto the surface of the article, (3) the chemical nature (e.g., electrostatic charge) of chemical groups on the surface of the article are altered, or (4) the surface properties of the article are otherwise modified. Exemplary surface treatment processes include, but are not limited to, a surface treatment by energy (e.g., a plasma, a static electrical charge, irradiation, or other energy source), chemical treatments, the grafting of hydrophilic vinylic monomers or macromers onto the surface of an article, mold-transfer coating process disclosed in U.S. Pat. No. 6,719,929, the incorporation of wetting agents into a lens formulation for making contact lenses proposed in U.S. Pat. Nos. 6,367,929 and 6,822,016, reinforced mold-transfer coating disclosed in U.S. Pat. No. 7,858,000, and a hydrophilic coating composed of covalent attachment or physical deposition of one or more layers of one or more hydrophilic polymer onto the surface of a contact lens disclosed in U.S. Pat. Nos. 8,147,897, 8,409,599, 8,557,334, 8,529,057, and 9,505,184.

A “hydrophilic surface” in reference to a SiHy material or a contact lens means that the SiHy material or the contact lens has a surface hydrophilicity characterized by having an averaged water contact angle of about 90 degrees or less, preferably about 80 degrees or less, more preferably about 70 degrees or less, more preferably about 60 degrees or less.

An “average contact angle” refers to a water contact angle (static water contact angle measured by Sessile Drop), which is obtained by averaging measurements of at least 3 individual contact lenses.

In general, the invention is directed to a UV/HEVL-filtering contact lens, more particularly, a UV/HEVL-filtering SiHy contact lens that not only has a relatively high UV/HEVL filtering capability but also has an aesthetic appealing color (i.e., minimizing an unappealingly yellow color). The present invention is partly based on the discovery that by incorporating an optical brightener into a UV/HEVL-filtering contact lens, one can minimizing an unappealingly yellow color derived from one or more HEVL-absorbers while not adversely decreasing HEVL % T of the HEVL-filtering contact lens.

The present invention provides a UV/HEVL-filtering contact lens, comprising a bulk silicone hydrogel material that comprises: (1) repeating units of at least one hydrophilic vinylic monomer; (2) repeating units of at least one silicone-containing vinylic monomer and/or at least one polysiloxane vinylic crosslinker; (3) repeating units of at least one UV-absorbing vinylic monomer; (4) repeating units of at least one polymerizable HEVL-absorbing compound capable of absorbing HEVL between 380 nm and 450 nm; (5) at least one blue-tinting agent distributed within the bulk silicone hydrogel material; and (6) at least one optical brightener distributed within the bulk silicone hydrogel material in an amount for provide the HEVL-filtering contact lens with a reduced b* value without decreasing HEVL % T of the HEVL-filtering contact lens, wherein the HEVL-filtering contact lens in fully hydrated state has a UVA % T of less than 5%, UVB % T of about 1% or less, a HEVL % T of about 65% or less (preferably about 55% or less, more preferably about 45% or less, even more preferably about 35% or less), and an averaged % transmission of at least 90% between 450 nm and 700 nm.

Any hydrophilic vinylic monomers can be used in the invention. A number of hydrophilic vinylic monomers have been commonly used in combination with other polymerizable components in making hydrogel contact lenses. Examples of preferred hydrophilic vinylic monomers include without limitation hydroxyethyl (meth)acrylate, glycerol (meth)acrylate, N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, di(ethylene glycol) (meth)acrylate, tri(ethylene glycol) (meth)acrylate, tetra(ethylene glycol) (meth)acrylate, poly(ethylene glycol) (meth)acrylate, N,N-dimethyl (meth)acrylamide, (meth)acrylamide, N-ethyl (meth)acrylamide, N,N-diethyl (meth)acrylamide, N-propyl (meth)acrylamide, N-isopropyl (meth)acrylamide, N-3-methoxy-propyl (meth)acrylamide, N-vinylpyrrolidone, N-vinyl-N-methyl acetamide, N-vinyl-N-ethyl acetamide, N-vinyl-N-ethyl formamide, 1-methyl-3-methylene-2-pyrrolidone, 1-methyl-5-methylene-2-pyrrolidone, 1-methyl-3-methylene-2-pyrrolidone, N-2-hydroxyethyl vinyl carbamate, N-carboxyvinyl-β-alanine (VINAL), N-carboxyvinyl-α-alanine, a phosphorylcholine-containing vinylic monomer, (meth)acrylic acid, vinyl alcohol, ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, poly(ethylene glycol) methyl ether, and combinations thereof.

Examples of preferred phosphorylcholine-containing vinylic monomers include without limitation (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]-propyl-2′-(trimethylammonio)-ethylphosphate, 4-[(meth)acryloylamino]butyl-2′-(trimethyl-ammonio)ethylphosphate, 5-((meth)acryloyloxy) pentyl-2′-(trimethylammonio)ethyl phosphate, 6-((meth)acryloyloxy) hexyl-2′-(trimethylammonio)-ethylphosphate, 2-((meth)acryloyloxy)ethyl-2′-(triethylammonio)-ethylphosphate, 2-((meth)acryloyloxy)ethyl-2′-(tripropylammonio)ethyl-phosphate, 2-((meth)acryloyloxy)ethyl-2′-(tributylammonio)ethyl phosphate, 2-((meth)acryloxy)-propyl-2′-(trimethylammonio)-ethylphosphate, 2-((meth)acryloyloxy)butyl-2′-(trimethylammonio)-ethylphosphate, 2-((meth)acryloyloxy) pentyl-2′-(trimethylammonio)ethylphosphate, 2-((meth)acryloxy) hexyl-2′-(trimethylammonio)ethyl phosphate, 2-(vinyloxy)ethyl-2′-(trimethyl-ammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)ethylphosphate, 2-(vinylcarbonyl-amino)ethyl-2′-(trimethylammonio)-ethylphosphate, 2-(allyloxycarbonylamino)ethyl-2′-(trimethylammonio)ethyl phosphate, 2-(butenoyloxy)ethyl-2′-(trimethylammonio)-ethylphosphate, and combinations thereof.

Any siloxane-containing vinylic monomer can be used in the invention. Examples of preferred siloxane-containing vinylic monomers can be siloxane-containing (meth)acrylamido monomers, siloxane-containing (meth)acryloxy monomers, siloxane-containing vinyloxy-carbonyloxy monomers, siloxane-containing vinyloxycarbonylamino monomers, siloxane-containing vinylaminocarbonylamino monomers, or siloxane-containing vinylaminocarbonyloxy monomers, each of which comprises a bis(trialkylsilyloxy)alkylsilyl group, a tris(trialkylsilyloxy)-silyl group, or a polysiloxane chain having 2 to 30 siloxane units and terminated with a C₁-C₆-alkyl, C₁-C₆-hydroxyalkyl or methoxy-C₁-C₆-alkyl group. Such preferred siloxane-containing vinylic monomers can be obtained from the commercial suppliers, or alternatively prepared according to known procedures, e.g., similar to those described in U.S. Pat. Nos. 5,070,215, 6,166,236, 6,867,245, 7,214,809, 8,415,405, 8,475,529, 8,614,261, 8,658,748, 9,097,840, 9,103,965, 9,217,813, 9,315,669, and 9,475,827, or by reacting a vinylic monomer having a reactive functional group (e.g., an acid chloride, acid anhydride, carboxyl, hydroxyl, amino, epoxy, isocyanate, aziridine, azlactone, or aldehyde group) with a siloxane-containing compound having a reactive group selected from the group consisting of a hydroxyalkyl, an aminoalkyl, an alkylaminoalkyl, a carboxyalkyl, an isocyanatoalkyl, an epoxyalkyl, and an aziridinylalkyl, in the presence or absence of a coupling agent under coupling reaction conditions well known to a skilled person.

Examples of preferred siloxane-containing vinylic monomers include without limitation tris(trimethylsilyloxy)silylpropyl (meth)acrylate, [3-(meth)acryloxy-2-hydroxypropyloxy]propyl-bis(trimethylsiloxy)methylsilane, [3-(meth)acryloxy-2-hydroxypropyloxy]propyl-bis(trimethylsiloxy)butylsilane, 3-(meth)acryloxy-2-(2-hydroxyethoxy)-propyloxy)propyl-bis(trimethylsiloxy)methylsilane, 3-(meth)acryloxy-2-hydroxypropyloxy)propyl-tris(trimethylsiloxy)silane, N-[tris(trimethylsiloxy)-silylpropyl]-(meth)acrylamide, N-(2-hydroxy-3-(3-(bis(trimethylsilyloxy)methylsilyl)-propyloxy)propyl)-2-methyl (meth)acrylamide, N-(2-hydroxy-3-(3-(bis(trimethylsilyloxy)-methylsilyl)propyloxy)-propyl) (meth)acrylamide, N-(2-hydroxy-3-(3-(tris(trimethylsilyloxy)-silyl)propyloxy)propyl)-2-methyl acrylamide, N-(2-hydroxy-3-(3-(tris(trimethylsilyloxy)silyl)-propyloxy)propyl) (meth)acrylamide, N-[tris(dimethylpropylsiloxy)-silylpropyl]-(meth)acrylamide, N-[tris(dimethylphenylsiloxy)-silylpropyl] (meth)acrylamide, N-[tris(dimethylethylsiloxy)-silylpropyl] (meth)acrylamide, N,N-bis [2-hydroxy-3-(3-(bis(trimethylsilyloxy)methylsilyl)-propyloxy)propyl]-2-methyl (meth)acrylamide, N,N-bis [2-hydroxy-3-(3-(bis(trimethylsilyloxy)methylsilyl)propyloxy)-propyl] (meth)acrylamide, N,N-bis [2-hydroxy-3-(3-(tris(trimethylsilyloxy)silyl)propyloxy)-propyl]-2-methyl (meth)acrylamide, N,N-bis [2-hydroxy-3-(3-(tris(trimethylsilyloxy)silyl)-propyloxy)propyl] (meth)acrylamide, N-[2-hydroxy-3-(3-(t-butyldimethylsilyl)propyloxy)-propyl]-2-methyl (meth)acrylamide, N-[2-hydroxy-3-(3-(t-butyldimethylsilyl)propyloxy)-propyl] (meth)acrylamide, N,N-bis [2-hydroxy-3-(3-(t-butyldimethylsilyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxycarbonylthio)-propyl-tris(trimethyl-siloxy)silane, 3-[tris(trimethylsiloxy)silyl]propylvinyl carbamate, 3-[tris(trimethylsiloxy)silyl]propyl allyl carbamate, 3-[tris(trimethylsiloxy)silyl]propyl vinyl carbonate, or a combination thereof.

Examples of preferred polysiloxane vinylic monomers include without limitation mono-(meth)acryloyl-terminated, monoalkyl-terminated polysiloxanes of formula (I) include without limitation α-(meth)acryloxypropyl terminated ω-butyl (or ω-methyl) terminated polydimethylsiloxane, α-(meth)acryloxy-2-hydroxypropyloxypropyl terminated ω-butyl (or ω-methyl) terminated polydimethylsiloxane, α-(2-hydroxyl-methacryloxypropyloxypropyl)-ω-butyl-decamethylpentasiloxane, α-[3-(meth)acryloxyethoxy-2-hydroxypropyloxypropyl]-terminated ω-butyl (or ω-methyl) terminated polydimethylsiloxane, α-[3-(meth)acryloxy-propyloxy-2-hydroxypropyloxypropyl]-terminated ω-butyl (or ω-methyl) terminated polydimethylsiloxane, α-[3-(meth)acryloxyisopropyloxy-2-hydroxypropyloxypropyl]-terminated ω-butyl (or ω-methyl) terminated polydimethylsiloxane, α-[3-(meth)acryloxybutyloxy-2-hydroxypropyloxypropyl]-terminated ω-butyl (or ω-methyl) terminated polydimethylsiloxane, α-[3-(meth)acryloxy-ethylamino-2-hydroxypropyloxypropyl]-terminated ω-butyl (or ω-methyl) terminated polydimethylsiloxane, α-[3-(meth)acryloxypropylamino-2-hydroxypropyloxypropyl]-terminated ω-butyl (or ω-methyl) terminated polydimethylsiloxane, α-[3-(meth)acryloxy-butylamino-2-hydroxypropyloxypropyl]-terminated ω-butyl (or ω-methyl) terminated polydimethylsiloxane, α-(meth)acryloxy (polyethylenoxy)-2-hydroxypropyloxypropyl]-terminated ω-butyl (or ω-methyl) terminated polydimethylsiloxane, α-[(meth)acryloxy-2-hydroxypropyloxy-ethoxypropyl]-terminated ω-butyl (or ω-methyl) terminated polydimethylsiloxane, α-[(meth)acryloxy-2-hydroxypropyl-N-ethylaminopropyl]-terminated ω-butyl (or ω-methyl) terminated polydimethylsiloxane, α-[(meth)acryloxy-2-hydroxypropyl-aminopropyl]-terminated ω-butyl (or ω-methyl) terminated polydimethylsiloxane, α-[(meth)acryloxy-2-hydroxypropyloxy-(polyethylenoxy)propyl]-terminated ω-butyl (or ω-methyl) terminated polydimethylsiloxane, α-(meth)acryloylamidopropyloxypropyl terminated ω-butyl (or ω-methyl) terminated polydimethylsiloxane, α-N-methyl-(meth)acryloylamidopropyloxypropyl terminated ω-butyl (or ω-methyl) terminated polydimethylsiloxane, α-[3-(meth)acrylamidoethoxy-2-hydroxypropyloxypropyl]-terminated ω-butyl (or ω-methyl) polydimethylsiloxane, α-[3-(meth)acrylamido-propyloxy-2-hydroxypropyloxypropyl]-terminated ω-butyl (or ω-methyl) terminated polydimethylsiloxane, α-[3-(meth)acrylamidoisopropyloxy-2-hydroxypropyloxypropyl]-terminated ω-butyl (or ω-methyl) terminated polydimethylsiloxane, α-[3-(meth)acrylamido-butyloxy-2-hydroxypropyloxypropyl]-terminated ω-butyl (or ω-methyl) terminated polydimethylsiloxane, α-[3-(meth)acryloylamido-2-hydroxypropyloxypropyl] terminated ω-butyl (or ω-methyl) polydimethylsiloxane, α-[3-[N-methyl-(meth)acryloylamido]-2-hydroxypropyloxypropyl] terminated ω-butyl (or ω-methyl) terminated polydimethylsiloxane, N-methyl-N′-(propyltetra(dimethylsiloxy)dimethylbutylsilane) (meth)acrylamide, N-(2,3-dihydroxypropane)-N′-(propyltetra(dimethylsiloxy)dimethylbutylsilane) (meth)acrylamide, (meth)acryloylamido-propyltetra(dimethylsiloxy)dimethylbutylsilane, mono-vinyl carbonate-terminated mono-alkyl-terminated polydimethylsiloxanes, mono-vinyl carbamate-terminated mono-alkyl-terminated polydimethylsiloxane, those disclosed in U.S. Pat. Nos. 9,097,840 and 9,103,965, and mixtures thereof. The above preferred polysiloxanes vinylic monomers can be obtained from commercial suppliers (e.g., Shin-Etsu, Gelest, etc.) or prepared according to procedures described in patents, e.g., U.S. Pat. Nos. 6,166,236, 6,867,245, 8,415,405, 8,475,529, 8,614,261, 9,217,813, and 9,315,669, or by reacting a hydroxyalkyl (meth)acrylate or (meth)acrylamide or a (meth)acryloxypolyethylene glycol with a mono-epoxypropyloxypropyl-terminated polydimethylsiloxane, by reacting glycidyl (meth)acrylate with a mono-carbinol-terminated polydimethylsiloxane, a mono-aminopropyl-terminated polydimethylsiloxane, or a mono-ethylaminopropyl-terminated polydimethylsiloxane, or by reacting isocyanatoethyl (meth)acrylate with a mono-carbinol-terminated polydimethylsiloxane according to coupling reactions well known to a person skilled in the art.

In accordance with the invention, any polysiloxane vinylic crosslinkers can be used in this invention. Examples of preferred polysiloxane vinylic crosslinkers include without limitation α,ω-(meth)acryloxy-terminated polydimethylsiloxanes of various molecular weight; α,ω-(meth)acrylamido-terminated polydimethylsiloxanes of various molecular weight; α,ω-vinyl carbonate-terminated polydimethylsiloxanes of various molecular weight; a, ω-vinyl carbamate-terminated polydimethylsiloxane of various molecular weight; bis-3-methacryloxy-2-hydroxypropyloxypropyl polydimethylsiloxane of various molecular weight; N,N,N′,N′-tetrakis (3-methacryloxy-2-hydroxypropyl)-alpha,omega-bis-3-aminopropyl-polydimethylsiloxane of various molecular weight; the reaction products of glycidyl methacrylate with amino-functional polydimethylsiloxanes; the reaction products of an azlactone-containing vinylic monomer (any one of those described above) with hydroxyl-functional polydimethylsiloxanes; polysiloxane-containing macromer selected from the group consisting of Macromer A, Macromer B, Macromer C, and Macromer D described in U.S. Pat. No. 5,760,100; polysiloxane vinylic crosslinkers disclosed in U.S. Pat. Nos. 4,136,250, 4,153,641, 4,182,822, 4,189,546, 4,259,467, 4,260,725, 4,261,875, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,449,729, 5,451,617, 5,486,579, 5,962,548, 5,981,675, 6,039,913, 6,762,264, 7,423,074, 8,163,206, 8,480,227, 8,529,057, 8,835,525, 8,993,651, 9,187,601, 10,081,697, 10,301,451, and 10,465,047.

One class of preferred polysiloxane vinylic crosslinkers are di-(meth)acryloyloxy-terminated polysiloxane vinylic crosslinkers each having dimethylsiloxane units and hydrophilized siloxane units each having one methyl substituent and one monovalent C₄-C₄₀ organic radical substituent having 2 to 6 hydroxyl groups, which can be prepared according to the procedures disclosed in U.S. patent Ser. No. 10/081,697.

Another class of preferred polysiloxane vinylic crosslinkers are vinylic crosslinkers each of which comprises one sole polysiloxane segment and two terminal (meth)acryloyl groups, which can be obtained from commercial suppliers; prepared by reacting glycidyl (meth)acrylate (meth)acryloyl chloride with a di-amino-terminated polydimethylsiloxane or a di-hydroxyl-terminated polydimethylsiloxane; prepared by reacting isocyantoethyl (meth)acrylate with di-hydroxyl-terminated polydimethylsiloxanes prepared by reacting an amino-containing acrylic monomer with di-carboxyl-terminated polydimethylsiloxane in the presence of a coupling agent (a carbodiimide); prepared by reacting a carboxyl-containing acrylic monomer with di-amino-terminated polydimethylsiloxane in the presence of a coupling agent (a carbodiimide); or prepared by reacting a hydroxyl-containing acrylic monomer with a dihydroxy-terminated polydisiloxane in the presence of a diisocyanate or diepoxy coupling agent.

Other classes of preferred polysiloxane vinylic crosslinkers are chain-extended polysiloxane vinylic crosslinkers each of which has at least two polysiloxane segments linked by a linker between each pair of polysiloxane segments and two terminal ethylenically unsaturated groups, which can be prepared according to the procedures described in U.S. Pat. Nos. 5,034,461, 5,416,132, 5,449,729, 5,760,100, 7,423,074, 8,529,057, 8,835,525, 8,993,651, 9,187,601, 10,301,451, and 10,465,047.

In accordance with the invention, any UV-absorbing vinylic monomers can be used in the invention, so long as they can provide Class I UV protection in combination with UV/HEVL-absorbing vinylic monomer. UV-absorbing vinylic monomers can be benzotriazole-containing vinylic monomers (i.e., ones each having a benzotriazole-moiety) and/or benzophenone-containing vinylic monomers (i.e., ones each having a benzophenone-moiety) known to a person skilled in the art. Preferably, at least one UV-absorbing vinylic monomer can be one or more benzotriazole-containing vinylic monomers (i.e., ones each having a benzotriazole-moiety) selected from the group consisting of 2-(2′-hydroxy-5′-vinylphenyl)-2H-benzotriazole, 2-(2′-hydroxy-5′-methacryloxyphenyl)-2H-benzotriazole, 2-(2′-hydroxy-5′-acryloyloxyphenyl)-2H-benzotriazole, 2-[2′-hydroxy-5′-(2-methacryloxyethyl)phenyl)]-2H-benzotriazole (Norbloc), 2-[2′-hydroxy-5′-(2-acryloxyethyl)phenyl)]-2H-benzotriazole, 2-(2′-hydroxy-5′-methacryloxypropyl-phenyl)-2H-benzotriazole, 2-(2′-hydroxy-5′-acryloxypropylphenyl)-2H-benzotriazole, and combinations thereof. More preferably, at least one UV-absorbing vinylic monomer is 2-[2′-hydroxy-5′-(2-methacryloxyethyl)phenyl)]-2H-benzotriazole (Norbloc).

Benzotriazole-containing UV-absorbing vinyl monomers can be prepared according to procedures described in U.S. Pat. Nos. 3,299,173, 4,612,358, 4,716,234, 4,528,311, 10,254,567 or can be obtained from commercial suppliers.

In accordance with the invention, any polymerizable UV/HEVL-absorbing compounds can be used in the invention, so long as they can absorb HEVL between 380 nm and 450 nm. Polymerizable HEVL-absorbing compounds can be benzotriazole-containing vinylic monomers (i.e., ones each having a benzotriazole-moiety), benzophenone-containing vinylic monomers (i.e., ones each having a benzophenone-moiety), Cu(II)-porphyrin derivatives each having a Soret peak (i.e., an absorption peak in a region from 395 nm to 435 nm) in visible absorption spectrum, reactive yellow dyes, as known to a person skilled in the art. Preferably, HEVL-absorbing benzotriazole-containing vinylic monomers and/or Cu(II)-porphyrin derivatives are used in the invention. Examples of preferred polymerizable HEVL-absorbing compounds include without limitation 2-{2′-Hydroxy-3′-tert-butyl-5′-[3′-methacryloyloxypropoxy]phenyl}-5-chloro-2H-benzotriazole (UV28) (having an HEVL absorption peak at 416 nm), 2-[2′-Hydroxy-3′-tert-butyl-5′-(3′-acryloyloxypropoxy)phenyl]-5-trifluoromethyl-2H-benzotriazole (UV23) (having an HEVL absorption peak at 418 nm), 2-{2′-Hydroxy-3′-tert-butyl-5′-[3′-methacryloyloxypropoxy]phenyl}-2H-benzotriazole (UV29), polymerizable Cu(II)-porphyrin derivatives, and combinations thereof.

Blue-tinting agents are known to a person skilled in the art and have been used in providing visibility blue-tint to commercial contact lenses in order for a wearer to see a contact lens immersed in a solution while not changing the wearer's eye color. Examples of preferred blue-tinting agents include without limitation Cu(II)-phthalocyanine pigment particles, polymerizable blue dyes, and combinations thereof. Examples of preferred polymerizable blue dyes include without limitation 1,4-bis(4-(2-methacryloxyethyl)phenylamino)anthraquinone (Reactive Blue 246), 1,4-bis((2-methacryloxy-ethyl)amino)anthraquinone (Reactive Blue 247).

In accordance with a preferred embodiment of the invention, the bulk silicone hydrogel material (in dried state) of UV/HEVL-filtering contact lens comprises from about 1.2% to about 3.5%, preferably from about 1.5% to about 3.0%, more preferably from about 1.5% to about 2.5% by weight of all components (3), (4) and (5). It is understood that weight percentages of components (3), (4) and (5) in the bulk silicone hydrogel material are determined based on their weight percentages in a polymerizable composition for forming the bulk silicone hydrogel material, relative to total weight of the polymerizable composition excluding non-reactive diluent(s).

An “optical brightener” generally refers to compounds that absorb ultraviolet light and re-emit lights in the blue region. It is believed that the blue light re-emitted by the brightener compensates for the diminishing blue from the absorbance in the blue region of HEVL absorbers, thereby decreasing the b* value when measured by X-rite.

The CIE (Commission Internationale de L'Eclairage) has standardized color order systems. The CIE L*a*b* Color System is used in the invention to express a color by the numbers. The lightness value, L*, also referred to as “Lstar,” defines black at 0 and white at 100. The a* axis is relative to the green-magenta opponent colors, with negative values toward green and positive values toward magenta. The b* axis represents the blue-yellow opponents, with negative numbers toward blue (i.e., a more appealing color) and positive toward yellow (i.e., a less appealing color). Those values can be determined in color measurements by X-rite, as illustrated in examples.

Suitable optical brighteners are bis(benzoxazol-2-yl) derivatives, distyrylbenzenes, distyrylbiphenyls, divinylstilbenes, triazinylaminostilbenes, stilbenyl-2H-triazoles, benzofurans, benzimidazoles, diphenyl pyrazolines, coumarins, naphthalimides, and the likes. Examples of preferred optical brighteners include without limitation 4,4′-Diamino-2,2′-stilbenedisultonic acid, 2,2′-(1,4-naphthalenediyl)bisbenzoxazole, 2,5-thiophenediylbis(5-tert-butyl-1,3-benzoxazole), 4,4′-bis(2-benzoxazolyl) stilbene, disodium-4,4′-bis(2-sulfonatostyryl)biphenyl, and combinations thereof.

A reduced b* value means that the value of b′ for a HEVL-filtering contact lens with an optical brightener distributed therein is lower than the value of b* for a control HEVL-filtering contact lens without optical brightener.

In a preferred embodiment, the optical brightener is present in an amount to reduce the value of b* by at least 10% (preferably by at least 15%, more preferably by at least 20%, even more preferably by at least 25%). This amount of reduction in b* value (i.e., Ab*) is calculated based on the following equation

$$Δ {b}^{*} = \frac{{b}_{0}^{*} - {b}_{t}^{*}}{{b}_{0}^{*}} \times 100 \%$$

in which b₀* is the value of b* for control lens and bₜ* is the value of b* for the testing lens. The testing lens and control lens are substantially identical in composition except that the testing lens contains an optical brightener distributed therein and the control lens is free of optical brightener.

In accordance with the invention, the bulk silicone hydrogel material can further comprise repeating units of at least one non-silicone hydrophobic vinylic monomer and/or at least one non-silicone vinylic crosslinker.

Any suitable no-silicone hydrophobic vinylic monomers can be used in the invention for forming the first and second hydrogel materials in combination with other polymerizable components. Examples of preferred hydrophobic non-silicone vinylic monomers include without limitation methyl (meth)acrylate, ethyl (meth)acrylate, methoxyethyl (meth)acrylate, propyl (meth)acrylate, isopropyl (meth)acrylate, cyclohexyl (meth)acrylate, 2-ethylhexyl (meth)acrylate, isobornyl (meth)acrylate, (meth)acrylonitrile, etc.), 2,2,2-trifluoroethyl (meth)acrylate, tetrafluoropropyl (meth)acrylate, hexafluoro-iso-propyl (meth)acrylate, hexafluorobutyl (meth)acrylate, heptafluorobutyl (meth)acrylate, octafluoropentyl (meth)acrylate, heptadecafluorodecyl (meth)acrylate, pentafluorophenyl (meth)acrylate, vinyl acetate, vinyl propionate, vinyl butyrate, vinyl valerate, vinyl ethyl ether, propyl vinyl ether, n-butyl vinyl ether, isoputyl vinyl ether, cyclohexyl vinyl ether, t-butyl vinyl ether, styrene, vinyl toluene, vinyl chloride, vinylidene chloride, 1-butene, and combinations thereof.

Any suitable no-silicone vinylic crosslinkers can be used in the invention for forming the first and second hydrogel materials in combination with other polymerizable components. Examples of preferred non-silicone vinylic crosslinkers include without limitation ethylene glycol di(meth)acrylate; 1,3-propanediol di(meth)acrylate; 2,3-propanediol di(meth)acrylate; 1,3-butanediol di-(meth)acrylate; 1,4-butanediol di(meth)acrylate; glycerol 1,3-diglycerolate di-(meth)acrylate; 1,5-pentanediol di(meth)acrylate; 1,6-hexanediol di(meth)acrylate; diethylene glycol di(meth)acrylate; triethylene glycol di(meth)acrylate; tetraethylene glycol di(meth)acrylate; ethylenebis [oxy (2-hydroxypropane-1,3-diyl)] di-(meth)acrylate; bis [2-(meth)acryloxyethyl] phosphate; 3,4-bis [(meth)acryloyl]tetrahydrofuran; di(meth)acrylamide; N,N-di(meth)acryloyl-N-methylamine; N,N-di(meth)acryloyl-N-ethylamine; N,N′-methylene bis((meth)acrylamide); N,N′-ethylene bis((meth)acrylamide); N,N′-hexamethylene bis-(meth)acrylamide; N,N′-dihydroxyethylene bis(meth)acrylamide; N,N′-propylene bis-(meth)acrylamide; N,N′-2-hydroxypropylene bis(meth)acrylamide; N,N′-2,3-dihydroxy-butylene bis(meth)acrylamide; 1,3-bis(meth)acrylamidepropane-2-yl dihydrogen phosphate; piperazine diacrylamide; pentaerythritol tri(meth)acrylate; trimethyloylpropane tri(meth)acrylate; tris(2-hydroxyethyl) isocyanurate tri(meth)acrylate; 1,3,5-tri(meth)acryloxyl-hexahydro-1,3,5-triazine; pentaerythritol tetra(meth)acrylate; di(trimethyloylpropane)tetra(meth)acrylate; tetraethyleneglycol divinyl ether, triethyleneglycol divinyl ether, diethyleneglycol divinyl ether, ethyleneglycol divinyl ether, triallyl isocyanurate, triallyl cyanurate, allylmethacrylate, allylacrylate, N-allyl-methacrylamide, N-allyl-acrylamide, or combinations thereof.

A HEVL-filtering contact lens of the invention can be obtained by first soaking in a solution of an optical brightener a preformed HEVL-filtering contact lens that is in dry state and free of any optical brightener, then being extracted with water or an aqueous solution, and finally being packaged and autoclaved in a packaging solution in a sealed lens package.

A preformed HEVL-filtering contact lens can be produced in a conventional “spin-casting mold,” as described for example in U.S. Pat. No. 3,408,429, or preferably by the full cast-molding process in a static form, as described in U.S. Pat. Nos. 4,347,198; 5,508,317; 5,583,463; 5,789,464; and 5,849,810, or by lathe cutting of polymeric material buttons as used in making customized contact lenses. In cast-molding, a polymerizable composition (i.e., a lens formulation) comprising UV-absorbing vinylic monomer and polymerizable HEVL-absorbing compound typically is dispensed into molds and cured (i.e., polymerized thermally or actinically) in molds for making HEVL-filtering contact lenses.

A polymerizable composition for forming a bulk silicone hydrogel material of the invention comprises: (1) at least one hydrophilic vinylic monomer (e.g., at least one of those described above); (2) at least one siloxane-containing vinylic monomer and/or at least one polysiloxane vinylic crosslinker (e.g., any one of those described in this application); (3) at least one UV-absorbing vinylic monomer (e.g., Norbloc or any one of those described in this application); (4) polymerizable HEVL-absorbing compound capable of absorbing HEVL between 380 nm and 450 nm (e.g., any one of those described above); (5) a blue-tinting agent (any one of those described above); (7) from about 0.2% to about 1.5% by weight of at least one free-radical initiator (e.g., any one of those described in this application); and (8) optionally at least one component selected from the group consisting of at least one hydrophobic non-silicone vinylic monomer (e.g., any one of those described in this application), at least one non-silicone vinylic crosslinker (e.g., any one of those described in this application), a leachable lubricant (e.g., a non-crosslinkable hydrophilic polymer having an average molecular weight from 5,000 to 500,000, preferably from 10,000 to 300,000, more preferably from 20,000 to 100,000 Daltons), a leachable tear-stabilizing agent (e.g., a phospholipid, a monoglyceride, a diglyceride, a triglyceride, a glycolipid, a glyceroglycolipid, a sphingolipid, a sphingo-glycolipid, a fatty acid having 8 to 36 carbon atoms, a fatty alcohol having 8 to 36 carbon atoms, or a mixture thereof), and combinations thereof.

In accordance with the invention, any thermal free-radical initiators can be used in the invention. Suitable thermal free-radical initiators are known to a skilled artisan and include, for example, peroxides, hydroperoxides, azo-bis(alkyl- or cycloalkylnitriles), persulfates, percarbonates, or mixtures thereof. Examples of preferred thermal free-radical initiators include without limitation benzoyl peroxide, t-butyl peroxide, t-amyl peroxybenzoate, 2,2-bis(tert-butylperoxy) butane, 1,1-bis(tert-butylperoxy)cyclohexane, 2,5-Bis (tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxy-phthalate, t-butyl hydroperoxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl) peroxy dicarbonate (Perkadox 16S), di(2-ethylhexyl) peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis [2-(2-imidazolin-2-yl) propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof.

In accordance with the invention, any photoinitiators can be used in the invention so long as it can generate free radicals for initiating polymerization reaction upon being irradiated with a visible light having a wavelength greater 440 nm. Examples of preferred photoinitiators include without limitation benzoylphosphine photoinitiators, acyl germanium photoinitiators (i.e., germanium-based Type I photoinitiators as described in U.S. Pat. No. 7,605,190), acyltin photoinitiators (e.g., tetrakis (2,4,6-trimethylbenzoyl) stannane or others described in U.S. patent application Ser. No. 18/308,210).

Examples of preferred benzoylphosphine initiators include without limitation 2,4,6-trimethylbenzoyldiphenylphosphine oxide (TPO); 2,4,6-trimethylbenzoylethoxy-phenylphosphine oxide (TPO-L); bis(2,4,6-trimethylbenzoyl)phenylphosphine oxide (BAPO); bis-(2,6-dichlorobenzoyl)-4-N-propylphenyl-phosphine oxide; bis-(2,6-dichlorobenzoyl)-4-N-butylphenylphosphine oxide; lithium phenyl (2,4,6-trimethylbenzoyl) phosphinate (LiTPO).

Examples of preferred acyl germanium photoinitiators include without limitation Bis (4-methoxybenzoyl) diethylgermanium (BMBDE-Ge), dibenzoyldiethylgermanium (DBDE-Ge), tetrakis (2-ethylbenzoyl)-germanium (TEB-Ge).

In accordance with the invention, a polymerizable composition of the invention is a fluid composition, which can be a solution (i.e., one including non-reactive diluent-solvent), a solventless blend (i.e., a fluid composition free of any non-reactive diluent-solvent).

Where a polymerizable composition of the invention is a solution. It can be prepared by dissolving all of the desirable components in any suitable solvent known to a person skilled in the art. Example of suitable solvents includes without limitation, water, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimethyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl, alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and mixtures thereof. Preferably, a polymerizable composition is a solution of all the desirable components in water, 1,2-propylene glycol, a polyethyleneglycol having a molecular weight of about 400 Daltons or less, or a mixture thereof.

Where a polymerizable composition of the invention is a solventless blend, it can be prepared by mixing all polymerizable components and other necessary component. A solventless polymerizable composition typically comprises at least one blending vinylic monomer as a reactive solvent for dissolving all other polymerizable components of the solventless polymerizable composition. Examples of preferred blending vinylic monomers are described later in this application. Preferably, methyl methacrylate is used as a blending vinylic monomer in preparing a solventless polymerizable composition.

Numerous lens formulations for forming silicone hydrogel contact lenses have been described in numerous patents and patent applications published by the filing date of this application and have been used in producing commercial SiHy contact lenses. Examples of commercial SiHy contact lenses include, without limitation, asmofilcon A, balafilcon A, comfilcon A, delefilcon A, efrofilcon A, enfilcon A, fanfilcon A, galyfilcon A, lotrafilcon A, lotrafilcon B, narafilcon A, narafilcon B, senofilcon A, senofilcon B, senofilcon C, smafilcon A, somofilcon A, and stenfilcon A. They can be used as a base formulation for forming a polymerizable composition for forming a bulk silicone hydrogel material of the invention by adding at least one UV-absorbing vinylic monomer, two HEVL-absorbing vinylic monomers, and at least one polymerizable blue dye in the base formulation.

Lens molds for making contact lenses including SiHy contact lenses are well known to a person skilled in the art and, for example, are employed in cast molding or spin casting. For example, a mold (for cast molding) generally comprises at least two mold sections (or portions) or mold halves, i.e., first and second mold halves. The first mold half defines a first molding (or optical) surface and the second mold half defines a second molding (or optical) surface. The first and second mold halves are configured to receive each other such that a lens-forming cavity is formed between the first molding surface and the second molding surface. The molding surface of a mold half is the cavity-forming surface of the mold and in direct contact with the polymerizable composition.

The mold halves can be formed through various techniques, such as injection molding. Methods of manufacturing mold halves for cast-molding a contact lens are generally well known to those of ordinary skill in the art. The process of the present invention is not limited to any particular method of forming a mold. In fact, any method of forming a mold can be used in the present invention. The mold halves can be formed through various techniques, such as injection molding or lathing. Examples of suitable processes for forming the mold halves are disclosed in U.S. Pat. Nos. 4,444,711; 4,460,534; 5,843,446; and 5,894,002.

Virtually all materials known in the art for making molds can be used to make molds for making contact lenses. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used. Other materials that allow UV light transmission could be used, such as quartz glass and sapphire.

In accordance with the invention, a polymerizable composition can be introduced (dispensed) into a cavity formed by a mold according to any known methods.

After the polymerizable composition is dispensed into the mold, it is polymerized to produce a contact lens. Crosslinking may be initiated thermally or actinically to crosslink the polymerizable components in the polymerizable composition.

The thermal polymerization is carried out conveniently, for example at a temperature of from 25 to 120° C. and preferably 40 to 100° C. The reaction time may vary within wide limits, but is conveniently, for example, from 30 minutes to 4 hours or preferably from 1 to 2 hours. It is advantageous to previously degas the components and solvents used in the polymerization reaction and to carry out said copolymerization reaction under an inert atmosphere, for example under a nitrogen or argon atmosphere.

The actinic polymerization can then be triggered off by actinic radiation, for example, a visible light of a suitable wavelength.

After the curing step, the steps of opening a mold (i.e., separating the male mold half from the female mold half with the contact lens attached onto one of the male and female mold halves and delensing (i.e., removing the contact lens from the lens adhered mold half) are carried out according to any techniques known to a person skilled in the art.

After the molded contact lens is delensed, it typically is extracted with an extraction medium as well known to a person skilled in the art. The extraction liquid medium is any solvent capable of dissolving the diluent(s), unpolymerized polymerizable materials, and oligomers in the lens precursor. Water, any organic solvents described above or known to a person skilled in the art, or a mixture thereof can be used in the invention.

The extracted contact lens can further subject to surface treatment to form coating on the surfaces of the preformed contact lenses.

The extracted and/or surface-treated contact lenses can then be dehydrated according to any method known to a person skilled in the art to obtain preformed HEVL-filtering contact lenses in dry state.

The preformed HEVL-filtering contact lenses in dry state can then be soaked in a solution comprising at least one optical brightener for a time sufficient long to upload the optical brightener into the polymer matrix of the preformed HEVL-filtering contact lenses. Subsequently, they can be extracted with water or an aqueous solution to remove excess optical brightener, and then can be packaged and autoclaved (at from 118° C. to 124° C. for at least about 30 minutes) in sealed lens packages with a packaging solution, well known to a skilled person.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

Alternatively, optical brightener can be chemically modified to introduce ethylenically unsaturated group(s). Such reactive optical brightener can be added into a lens formulation for cast-molding directly HEVL-absorbing contact lenses of the invention.

A contact lens of the invention has an oxygen permeability of preferably at least about 40 barrers, more preferably at least about 60 barrers, even more preferably at least about 80 barrers (at about 35° C.).

A contact lens of the invention has an elastic modulus of about 1.5 MPa or less, preferably about 1.2 MPa or less, more preferably from about 0.3 MPa to about 1.0 MPa (at a temperature of from about 22° C. to 28° C.).

A contact lens of the invention further has an equilibrium water content of from about 15% to about 75%, more preferably from about 20% to about 70% by weight, even more preferably from about 25% to about 65% by weight (at room temperature) when fully hydrated. The equilibrium water content of a photochromic SiHy contact lens can be measured according to the procedure disclosed in Example 1.

In another aspects, the invention provides method for making UV/HEVL-filtering silicone hydrogel contact lenses, comprising the steps of: (1) obtaining preformed HEVL-filtering silicone hydrogel contact lenses each free of optical brightener; (2) drying the preformed HEVL-filtering silicone hydrogel contact lenses; (3) soaking the preformed HEVL-silicone hydrogel contact lens in dry state obtained step (2) in a solution comprising at least one optical brightener for sufficient long to allow the optical brightener to penetrate into and distribute in the preformed HEVL-filtering silicone hydrogel contact lenses; (4) washing the preformed HEVL-filtering silicone hydrogel contact lenses having the optical brightener distributed therein with water or an aqueous solution to remove excess optical brightener while retaining the optical brightener in an amount for provide the HEVL-filtering contact lens with a reduced b* value without decreasing HEVL % T of the HEVL-filtering contact lens; and (5) packaging and autoclaving the preformed HEVL-filtering silicone hydrogel contact lenses obtained in step (4) in a packaging solution in a sealed lens package, wherein each of the HEVL-filtering silicone hydrogel contact lenses in fully hydrated state has a UVA % T of less than 5%, UVB % T of about 1% or less, a HEVL % T of about 65% or less, and an averaged % transmission of at least 90% between 450 nm and 700 nm and comprises a bulk silicone hydrogel material that comprises the optical brightener distributed therein and repeating units of (a) at least one hydrophilic vinylic monomer, (b) at least one siloxane-containing vinylic monomer and/or at least one polysiloxane vinylic crosslinker, (c) at least one UV-absorbing vinylic monomer, (d) at least one polymerizable HEVL-absorbing compound capable of absorbing HEVL between 380 nm and 450 nm, and (e) at least blue-tinting agent.

In a further aspects, the invention provides method for making UV/HEVL-filtering silicone hydrogel contact lenses, comprising the steps of: (1) introducing a polymerizable composition into a mold, wherein the polymerizable composition comprises (a) at least one hydrophilic vinylic monomer, (b) at least one siloxane-containing vinylic monomer and/or at least one polysiloxane vinylic crosslinker, (c) at least one UV-absorbing vinylic monomer, (d) at least one polymerizable HEVL-absorbing compound capable of absorbing HEVL between 380 nm and 450 nm, (e) at least blue-tinting agent present in an amount for provide the HEVL-filtering contact lens with a reduced b* value without decreasing HEVL % T of the HEVL-filtering contact lens; (f) at least one reactive optical brightener, and (g) from about 0.2% to about 1.5% by weight of at least one free-radical initiator, wherein the mold comprises a female mold halve having a first molding surface and a male mold half having a second molding surface, wherein the mold halves are configured to receive each other such that a lens-forming cavity is formed between the first molding surface and the second molding surface; (2) curing the polymerizable composition in the mold to form a UV/HEVL-filtering silicone hydrogel contact lens precursor; (3) removing the UV/HEVL-filtering silicone hydrogel contact lens precursor from the mold; and subjecting the UV/HEVL-filtering silicone hydrogel contact lens precursor to one or more post-molding processes selected from the group consisting of extraction, hydration, surface treatment, packaging, sterilization, and combinations thereof, wherein each of the HEVL-filtering silicone hydrogel contact lenses in fully hydrated state has a UVA % T of less than 5%, UVB % T of about 1% or less, a HEVL % T of about 65% or less, and an averaged % transmission of at least 90% between 450 nm and 700 nm.

All of the various embodiments of polymerizable compositions, hydrophilic vinylic monomers, silicone-containing vinylic monomers, polysiloxane vinylic crosslinkers, UV-absorbing vinylic monomers, polymerizable HEVL-absorbing compounds, blue tinting agents, non-silicone hydrophobic vinylic monomers, non-silicone vinylic crosslinkers, free-radical initiators, molds, thermal curing, photocuring, demolding, delensing, extraction, hydration, surface treatment, packaging, and autoclaving have been described above and can be used in these aspects of the invention.

Although various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part or can be combined in any manner and/or used together, as illustrated below:
1. A UV/HEVL-filtering silicone hydrogel contact lens, comprising a bulk silicone hydrogel material that comprises:
   (1) repeating units of at least one hydrophilic vinylic monomer;
   (2) repeating units of at least one silicone-containing vinylic monomer and/or at least one polysiloxane vinylic crosslinker;
   (3) repeating units of at least one UV-absorbing vinylic monomer;
   (4) repeating units of at least one polymerizable HEVL-absorbing compound capable of absorbing HEVL between 380 nm and 450 nm;
   (5) at least one blue-tinting agent distributed within the bulk silicone hydrogel material; and
   (5) at least one optical brightener distributed within the bulk silicone hydrogel material in an amount for provide the HEVL-filtering contact lens with a reduced b* value without decreasing HEVL % T of the HEVL-filtering contact lens,
   wherein the HEVL-filtering contact lens in fully hydrated state has a UVA % T of less than 5%, UVB % T of about 1% or less, a HEVL % T of about 65% or less, and an averaged % transmission of at least 90% between 450 nm and 700 nm.
2. The UV/HEVL-filtering silicone hydrogel contact lens of embodiment 1, wherein the UV/HEVL-filtering silicone hydrogel contact lens in fully hydrated state has a HEVL % T of about 55% or less.
3. The UV/HEVL-filtering silicone hydrogel contact lens of embodiment 1, wherein the UV/HEVL-filtering silicone hydrogel contact lens in fully hydrated state has a HEVL % T of about 45% or less.
4. The UV/HEVL-filtering silicone hydrogel contact lens of embodiment 1, wherein the UV/HEVL-filtering silicone hydrogel contact lens in fully hydrated state has a HEVL % T of about 35% or less.
5. The UV/HEVL-filtering silicone hydrogel contact lens of any one of embodiments 1 to 4, wherein the UV/HEVL-filtering silicone hydrogel contact lens in fully hydrated has a reduction in b* value of at least 10% relative to a control UV-HEVL-filtering silicone hydrogel contact lens free of optical brightener.
6. The UV/HEVL-filtering silicone hydrogel contact lens of any one of embodiments 1 to 4, wherein the UV/HEVL-filtering silicone hydrogel contact lens in fully hydrated has a reduction in b* value of at least 15% relative to a control UV-HEVL-filtering silicone hydrogel contact lens free of optical brightener.
7. The UV/HEVL-filtering silicone hydrogel contact lens of any one of embodiments 1 to 4, wherein the UV/HEVL-filtering silicone hydrogel contact lens in fully hydrated has a reduction in b* value of at least 20% relative to a control UV-HEVL-filtering silicone hydrogel contact lens free of optical brightener.
8. The UV/HEVL-filtering silicone hydrogel contact lens of any one of embodiments 1 to 4, wherein the UV/HEVL-filtering silicone hydrogel contact lens in fully hydrated has a reduction in b* value of at least 10% relative to a control UV-HEVL-filtering silicone hydrogel contact lens free of optical brightener.
9. The UV/HEVL-filtering silicone hydrogel contact lens of any one of embodiments 1 to 8, wherein said at least one UV-absorbing vinylic monomer comprises a benzotriazole-containing vinylic monomer.
10. The UV/HEVL-filtering silicone hydrogel contact lens of embodiment 9, wherein said at least one UV-absorbing vinylic monomer comprises 2-(2′-hydroxy-5′-vinylphenyl)-2H-benzotriazole, 2-(2′-hydroxy-5′-methacryloxyphenyl)-2H-benzotriazole, 2-(2′-hydroxy-5′-acryloxyphenyl)-2H-benzotriazole, 2-[2′-hydroxy-5′-(2-methacryloxyethyl)phenyl)]-2H-benzotriazole, 2-[2′-hydroxy-5′-(2-acryloxyethyl)phenyl)]-2H-benzotriazole, 2-(2′-hydroxy-5′-methacryloxy-propyl-phenyl)-2H-benzotriazole, 2-(2′-hydroxy-5′-acryloxypropylphenyl)-2H-benzotriazole, or combinations thereof.
11. The UV/HEVL-filtering silicone hydrogel contact lens of embodiment 9, wherein said at least one UV-absorbing vinylic monomer is 2-[2′-hydroxy-5′-(2-methacryloxyethyl)phenyl)]-2H-benzotriazole.
12. The UV/HEVL-filtering silicone hydrogel contact lens of any one of embodiments 1 to 11, wherein said at least one polymerizable HEVL-absorbing compound comprises 2-{2′-Hydroxy-3′-tert-butyl-5′-[3′-methacryloyloxypropoxy]phenyl}-5-chloro-2H-benzotriazole, 2-[2′-Hydroxy-3′-tert-butyl-5′-(3′-acryloyloxypropoxy)phenyl]-5-trifluoromethyl-2H-benzotriazole, or combinations thereof.
13. The UV/HEVL-filtering silicone hydrogel contact lens of any one of embodiments 1 to 12, wherein said at least one polymerizable HEVL-absorbing compound comprises at least one polymerizable Cu(II)-porphyrin derivative.
14. The UV/HEVL-filtering silicone hydrogel contact lens of any one of embodiments 1 to 13, wherein the bulk silicone hydrogel material in dried state comprises from about 1.2% to about 3.5% by weight of all components (3), (4) and (5).
15. The UV/HEVL-filtering silicone hydrogel contact lens of any one of embodiments 1 to 13, wherein the bulk silicone hydrogel material in dried state comprises from about 1.5% to about 3.0% by weight of all components (3), (4) and (5).
16. The UV/HEVL-filtering silicone hydrogel contact lens of any one of embodiments 1 to 14, wherein the bulk silicone hydrogel material in dried state comprises from about 1.5% to about 2.5% by weight of all components (3), (4) and (5).
17. The UV/HEVL-filtering silicone hydrogel contact lens of any one of embodiments 1 to 16, wherein weight ratio of component (4) over component (5) is from about 0.25 to about 2.5.
18. The UV/HEVL-filtering silicone hydrogel contact lens of any one of embodiments 1 to 16, wherein weight ratio of component (4) over component (5) is from about 0.5 to about 2.0.
19. The UV/HEVL-filtering silicone hydrogel contact lens of any one of embodiments 1 to 18, wherein the bulk silicone hydrogel material comprises Cu(II)-phthalocyanine pigment particles distributed therein.
20. The UV/HEVL-filtering silicone hydrogel contact lens of any one of embodiments 1 to 18, wherein the bulk silicone hydrogel material comprises repeating units of at least one polymerizable blue dye.
21. The UV/HEVL-filtering silicone hydrogel contact lens of any one of embodiments 1 to 18, wherein said at least one polymerizable blue dye is 1,4-bis(4-(2-methacryloxyethyl)phenylamino)anthraquinone, 1,4-bis((2-methacryloxy-ethyl)amino)anthraquinone, or combinations thereof.
22. The UV/HEVL-filtering silicone hydrogel contact lens of any one of embodiments 1 to 21, wherein said at least one optical brightener comprises a bis(benzoxazol-2-yl) derivative, a distyrylbenzene, a distyrylbiphenyl, a divinylstilbene, a triazinylaminostilbene, a stilbenyl-2H-triazole, a benzofuran, a benzimidazole, a diphenyl pyrazoline, a coumarin, a naphthalimide, or combinations thereof.
23. The UV/HEVL-filtering silicone hydrogel contact lens of any one of embodiments 1 to 21, wherein said at least one optical brightener comprises 4,4′-Diamino-2,2′-stilbenedisulfonic acid, 2,2′-(1,4-naphthalenediyl)bisbenzoxazole, 2,5-thiophenediylbis(5-tert-butyl-1,3-benzoxazole), 4,4′-bis(2-benzoxazolyl) stilbene, disodium-4,4′-bis(2-sulfonatostyryl)-biphenyl, or combinations thereof.
24. The UV/HEVL-filtering silicone hydrogel contact lens of any one of embodiments 1 to 23, wherein said at least one hydrophilic vinylic monomer comprises hydroxyethyl (meth)acrylate, glycerol (meth)acrylate, N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, di(ethylene glycol) (meth)acrylate, tri(ethylene glycol) (meth)acrylate, tetra(ethylene glycol) (meth)acrylate, poly(ethylene glycol) (meth)acrylate, N,N-dimethyl (meth)acrylamide, (meth)acrylamide, N-ethyl (meth)acrylamide, N,N-diethyl (meth)acrylamide, N-propyl (meth)acrylamide, N-isopropyl (meth)acrylamide, N-3-methoxy-propyl (meth)acrylamide, N-vinylpyrrolidone, N-vinyl-N-methyl acetamide, N-vinyl-N-ethyl acetamide, N-vinyl-N-ethyl formamide, 1-methyl-3-methylene-2-pyrrolidone, 1-methyl-5-methylene-2-pyrrolidone, 1-methyl-3-methylene-2-pyrrolidone, N-2-hydroxyethyl vinyl carbamate, N-carboxyvinyl-β-alanine (VINAL), N-carboxyvinyl-α-alanine, a phosphorylcholine-containing vinylic monomer, (meth)acrylic acid, vinyl alcohol, ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, poly(ethylene glycol) methyl ether, or combinations thereof.
25. The UV/HEVL-filtering silicone hydrogel contact lens of any one of embodiments 1 to 24, wherein the bulk silicone hydrogel material comprises repeating units of at least one siloxane-containing vinylic monomer which is a siloxane-containing vinylic monomer having a bis(trialkylsilyloxy)-alkylsilyl group or a tris(trialkylsilyloxy)silyl group, a polysiloxane vinylic monomer, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, or combinations thereof.
26. The UV/HEVL-filtering silicone hydrogel contact lens of any one of embodiments 1 to 25, wherein the bulk silicone hydrogel material comprises repeating units of at least one polysiloxane vinylic crosslinker.
27. The UV/HEVL-filtering silicone hydrogel contact lens of embodiment 26, wherein said at least one polysiloxane vinylic crosslinker comprises a vinylic crosslinker having one sole polysiloxane segment and two ethylenically unsaturated groups.
28. The UV/HEVL-filtering silicone hydrogel contact lens of embodiment 26, wherein said at least one polysiloxane vinylic crosslinker comprises a chain-extended polysiloxane vinylic crosslinker having at least two polysiloxane segments linked by a linker between each pair of polysiloxane segments and two terminal ethylenically unsaturated groups.
29. The UV/HEVL-filtering silicone hydrogel contact lens of embodiment 26, wherein said at least one polysiloxane vinylic crosslinker comprises a di-(meth)acryloyloxy-terminated polysiloxane vinylic crosslinker having dimethylsiloxane units and hydrophilized siloxane units each having one methyl substituent and one monovalent C₄-C₄₀ organic radical substituent having 2 to 6 hydroxyl groups.
30. The UV/HEVL-filtering silicone hydrogel contact lens of any one of embodiments 1 to 29, wherein the bulk silicone hydrogel material further comprises repeating units of at least one non-silicone hydrophobic vinylic monomer, at least one non-silicone vinylic crosslinker, or combinations thereof.
31. The UV/HEVL-filtering silicone hydrogel contact lens of any one of embodiments 1 to 30, wherein the UV/HEVL-filtering silicone hydrogel contact lens has an oxygen permeability of at least 60 barrers (at about 35° C.) when being fully hydrated.
32. The UV/HEVL-filtering silicone hydrogel contact lens of any one of embodiments 1 to 30, wherein the UV/HEVL-filtering silicone hydrogel contact lens has an oxygen permeability of at least 70 barrers (at about 35° C.) when being fully hydrated.
33. The UV/HEVL-filtering silicone hydrogel contact lens of any one of embodiments 1 to 30, wherein the UV/HEVL-filtering silicone hydrogel contact lens has an oxygen permeability of at least 80 barrers (at about 35° C.) when being fully hydrated.
34. The UV/HEVL-filtering silicone hydrogel contact lens of any one of embodiments 1 to 33, wherein the UV/HEVL-filtering silicone hydrogel contact lens has an elastic modulus of about 2.0 MPa or less (at a temperature of from 22° C. to 28° C.) when being fully hydrated.
35. The UV/HEVL-filtering silicone hydrogel contact lens of any one of embodiments 1 to 33, wherein the UV/HEVL-filtering silicone hydrogel contact lens has an elastic modulus of about 1.5 MPa or less (at a temperature of from 22° C. to 28° C.) when being fully hydrated.
36. The UV/HEVL-filtering silicone hydrogel contact lens of any one of embodiments 1 to 33, wherein the UV/HEVL-filtering silicone hydrogel contact lens has an elastic modulus of about 1.2 or less (at a temperature of from 22° C. to 28° C.) when being fully hydrated.
37. The UV/HEVL-filtering silicone hydrogel contact lens of any one of embodiments 1 to 36, wherein the UV/HEVL-filtering silicone hydrogel contact lens has an elastic modulus of from about 0.4 MPa to about 1.0 MPa (at a temperature of from 22° C. to 28° C.) when being fully hydrated.
38. The UV/HEVL-filtering silicone hydrogel contact lens of any one of embodiments 1 to 37, wherein the UV/HEVL-filtering silicone hydrogel contact lens has a water content of from about 15% to about 70% (at a temperature of from 22° C. to 28° C.) when being fully hydrated.
39. The UV/HEVL-filtering silicone hydrogel contact lens of any one of embodiments 1 to 37, wherein the UV/HEVL-filtering silicone hydrogel contact lens has a water content of from about 20% to about 70% (at a temperature of from 22° C. to 28° C.) when being fully hydrated.
40. The UV/HEVL-filtering silicone hydrogel contact lens of any one of embodiments 1 to 37, wherein the UV/HEVL-filtering silicone hydrogel contact lens has a water content of from about 25% to about 70% (at a temperature of from 22° C. to 28° C.) when being fully hydrated.
41. The UV/HEVL-filtering silicone hydrogel contact lens of any one of embodiments 1 to 37, wherein the UV/HEVL-filtering silicone hydrogel contact lens has a water content of from about 30% to about 65% (at a temperature of from 22° C. to 28° C.) when being fully hydrated.
42. A method for producing HEVL-filtering silicone hydrogel contact lenses, comprising the steps of:
   (1) obtaining preformed HEVL-filtering silicone hydrogel contact lenses each free of optical brightener;
   (2) drying the preformed HEVL-filtering silicone hydrogel contact lenses;
   (3) soaking the preformed HEVL-silicone hydrogel contact lenses in dry state obtained step (2) in a solution comprising at least one optical brightener for sufficient long to allow the optical brightener to penetrate into and distribute in each of the preformed HEVL-filtering silicone hydrogel contact lenses;
   (4) washing the preformed HEVL-filtering silicone hydrogel contact lenses having the optical brightener distributed therein with water or an aqueous solution to remove excess optical brightener while retaining the optical brightener in an amount for provide the HEVL-filtering contact lens with a reduced b* value without decreasing HEVL % T of the HEVL-filtering contact lens; and
   (5) packaging and autoclaving the preformed HEVL-filtering silicone hydrogel contact lenses obtained in step (4) in a packaging solution in a sealed lens package,
   wherein each of the HEVL-filtering silicone hydrogel contact lenses in fully hydrated state has a UVA % T of less than 5%, UVB % T of about 1% or less, a HEVL % T of about 65% or less, and an averaged % transmission of at least 90% between 450 nm and 700 nm and comprises a bulk silicone hydrogel material that comprises the optical brightener distributed therein and repeating units of (a) at least one hydrophilic vinylic monomer, (b) at least one siloxane-containing vinylic monomer and/or at least one polysiloxane vinylic crosslinker, (c) at least one UV-absorbing vinylic monomer, (d) at least one polymerizable HEVL-absorbing compound capable of absorbing HEVL between 380 nm and 450 nm, and (e) at least blue-tinting agent.
43. A method for producing HEVL-filtering silicone hydrogel contact lenses, comprising the steps of:
   (1) introducing a polymerizable composition into a mold, wherein the polymerizable composition comprises (a) at least one hydrophilic vinylic monomer, (b) at least one siloxane-containing vinylic monomer and/or at least one polysiloxane vinylic crosslinker, (c) at least one UV-absorbing vinylic monomer, (d) at least one polymerizable HEVL-absorbing compound capable of absorbing HEVL between 380 nm and 450 nm, (e) at least blue-tinting agent; (f) at least one reactive optical brightener present in an amount for provide the HEVL-filtering contact lens with a reduced b* value without decreasing HEVL % T of the HEVL-filtering contact lens, and (g) from about 0.2% to about 1.5% by weight of at least one free-radical initiator, wherein the mold comprises a female mold halve having a first molding surface and a male mold half having a second molding surface, wherein the mold halves are configured to receive each other such that a lens-forming cavity is formed between the first molding surface and the second molding surface;
   (2) curing the polymerizable composition in the mold to form a UV/HEVL-filtering silicone hydrogel contact lens precursor;
   (3) removing the UV/HEVL-filtering silicone hydrogel contact lens precursor from the mold; and
   (4) subjecting the UV/HEVL-filtering silicone hydrogel contact lens precursor to one or more post-molding processes selected from the group consisting of extraction, hydration, surface treatment, packaging, sterilization, and combinations thereof,
   wherein each of the HEVL-filtering silicone hydrogel contact lenses in fully hydrated state has a UVA % T of less than 5%, UVB % T of about 1% or less, a HEVL % T of about 65% or less, and an averaged % transmission of at least 90% between 450 nm and 700 nm.
44. The method of embodiment 42 or 43, wherein said at least one optical brightener comprises a bis(benzoxazol-2-yl) derivative, a distyrylbenzene, a distyrylbiphenyl, a divinylstilbene, a triazinylaminostilbene, a stilbenyl-2H-triazole, a benzofuran, a benzimidazole, a diphenyl pyrazoline, a coumarin, a naphthalimide, or combinations thereof.
45. The method of embodiment 42 or 43, wherein said at least one optical brightener comprises a bis(benzoxazol-2-yl) derivative, a distyrylbenzene, a distyrylbiphenyl, a divinylstilbene, a triazinylaminostilbene, a stilbenyl-2H-triazole, a benzofuran, a benzimidazole, a diphenyl pyrazoline, a coumarin, a naphthalimide, or combinations thereof.
46. The method of any one of embodiments 42 to 44, wherein said at least one blue-tinting agent comprises Cu(II)-phthalocyanine pigment particles.
47. The method of any one of embodiments 42 to 44, wherein said at least one blue-tinting agent comprises at least one polymerizable blue dye.
48. The method of embodiment 47, wherein said at least one polymerizable blue dye comprises 1,4-bis(4-(2-methacryloxyethyl)phenylamino)anthraquinone, 1,4-bis((2-methacryloxy-ethyl)amino)anthraquinone, or combinations thereof.
49. The method of any one of embodiments 42 to 48, wherein said at least one UV-absorbing vinylic monomer comprises 2-(2′-hydroxy-5′-vinylphenyl)-2H-benzotriazole, 2-(2′-hydroxy-5′-methacryloxyphenyl)-2H-benzotriazole, 2-(2′-hydroxy-5′-acryloyloxyphenyl)-2H-benzotriazole, 2-[2′-hydroxy-5′-(2-methacryloxyethyl)phenyl)]-2H-benzotriazole (Norbloc), 2-[2′-hydroxy-5′-(2-acryloxyethyl)phenyl)]-2H-benzotriazole, 2-(2′-hydroxy-5′-methacryloxypropyl-phenyl)-2H-benzotriazole, 2-(2′-hydroxy-5′-acryloxypropylphenyl)-2H-benzotriazole, or combinations thereof.
50. The method of any one of embodiments 42 to 49, wherein said at least one polymerizable HEVL-absorbing compound comprises 2-{2′-Hydroxy-3′-tert-butyl-5′-[3′-methacryloxypropoxy]-phenyl}-5-chloro-2H-benzotriazole, 2-[2′-Hydroxy-3′-tert-butyl-5′-(3′-acryloxypropoxy)-phenyl]-5-trifluoromethyl-2H-benzotriazole, or combinations thereof.
51. The method of any one of embodiments 42 to 49, wherein said at least one polymerizable HEVL-absorbing compound comprises at least one polymerizable HEVL-absorbing compound comprises at least one polymerizable Cu(II)-porphyrin derivative.
52. The method of any one of embodiments 43 to 51, wherein said at least one free-radical initiator is a thermal initiator, wherein the polymerizable composition is cured thermally.
53. The method of any one of embodiments 43 to 51, wherein said at least one free-radical initiator is a visible light photoinitiator, wherein the polymerizable composition is cured with a visible light having a wavelength of from 450 nm to 510 nm.
54. The method of embodiment 53, wherein the visible light photoinitiator is a benzoylphosphine photoinitiator, an acyl germanium photoinitiator, and/or an acyltin photoinitiator.
55. The method of embodiment 53, wherein the visible light photoinitiator is an acyl germanium photoinitiator.

The previous disclosure will enable one having ordinary skill in the art to practice the invention. Various modifications, variations, and combinations can be made to the various embodiment described herein. In order to better enable the reader to understand specific embodiments and the advantages thereof, reference to the following examples is suggested. It is intended that the specification and examples be considered as exemplary.

### Example 1

### Oxygen Permeability Measurements

Unless specified, the oxygen transmissibility (Dk/t), the intrinsic (or edge-corrected) oxygen permeability (Dkᵢ or Dk_{c}) of a lens and a lens material are determined according to procedures described in ISO 18369-4.

### Equilibrium Water Content

The equilibrium water content (EWC) of contact lenses are determined as follows.

Amount of water (expressed as percent by weight) present in a hydrated hydrogel contact lens, which is fully equilibrated in saline solution, is determined at room temperature. Quickly stack the lenses and transfer the lens stack to the aluminum pan on the analytical balance after blotting lens in a cloth. The number of lenses for each sample pan is typically five (5). Record the pan plus hydrated weight of the lenses. Cover the pan with aluminum foil. Place pans in a laboratory oven at 100±2° C. to dry for 16-18 hours. Remove pan plus lenses from the oven and cool in a desiccator for at least 30 minutes. Remove a single pan from the desiccator, and discard the aluminum foil. Weigh the pan plus dried lens sample on an analytical balance. Repeat for all pans. The wet and dry weight of the lens samples can be calculated by subtracting the weight of the empty weigh pan.

### Elastic Modulus

The elastic modulus of a contact lens is determined using a MTS insight instrument. The contact lens is first cut into a 3.12 mm wide strip using Precision Concept two stage cutter. Five thickness values are measured within 6.5 mm gauge length. The strip is mounted on the instrument grips and submerged in PBS (phosphate buffered saline) with the temperature controlled at 21±2° C. Typically 5N Load cell is used for the test. Constant force and speed is applied to the sample until the sample breaks. Force and displacement data are collected by the TestWorks software. The elastic modulus value is calculated by the TestWorks software which is the slope or tangent of the stress vs. strain curve near zero elongation, in the elastic deformation region.

### Transmittance

Contact lenses are manually placed into a specially fabricated sample holder or the like which can maintain the shape of the lens as it would be when placing onto eye. This holder is then submerged into a 1 cm path-length quartz cell containing phosphate buffered saline (PBS, PH ˜7.0-7.4) as the reference. A UV/visible spectrophotmeter, such as, Varian Cary 3E UV-Visible Spectrophotometer with a LabSphere DRA-CA-302 beam splitter or the like, can be used in this measurement. Percent transmission spectra are collected at a wavelength range of 250-800 nm with % T values collected at 1.0 nm intervals. This data is transposed onto an Excel spreadsheet and used to determine if the lenses conform to Class 1 UV absorbance. Transmittance is calculated using the following equations:

UVA % T=Average % Transmission between 315 nm and 380 nm×100

UVB % T=Average % Transmission between 280 nm and 315 nm×100

HEVL % T=Average % Transmission between 380 nm and 450 nm×100.

### Chemicals

MCR-M07 represents monomethacryloxypropyl-terminated butyl terminated polydimethylsiloxane (Mw: 600-800 Daltons); MMA represents methyl methacrylate; NVP represents N-vinylpyrrolidone; EGMA represents ethylene glycol methyl ether methacrylate; TEGDMA represents triethyleneglycol dimethacrylate; AMA represents allyl methacrylate; DMA represent N,N-dimethylacrylamide; L-PEG 2000 represents N-(carbonyl-methoxypolyethylene glycol-2000)-1,2-distearoyl-sn-glycero-3-phosphoethanolamin, sodium salt; DMPC represents 1,2-dimyristoyl-sn-glycero-3-phosphocholine; H-TEMPO represents 4-hydroxy-2,2,6,6-tetramethylpiperidin-1-oxyl; Norbloc is 2-[2′-hydroxy-5′-(2-methacryloxyethyl)phenyl)]-2H-benzotriazole from Aldrich; PrOH represents n-propanol; UV28 represents 2-{2′-Hydroxy-3′-tert-butyl-5′-[3′-methacryloyloxypropoxy]phenyl}-5-chloro-2H-benzotriazole; UV23 represents 2-[2′-Hydroxy-3′-tert-butyl-5′-(3′-acryloyloxypropoxy)phenyl]-5-trifluoromethyl-2H-benzotriazole; RB247 represents 1,4-bis((2-methacryloxyethyl)amino)-anthraquinone (Reactive Blue 247); VAZO 64 represents 2,2′-dimethyl-2,2′azodipropiononitrile; BMBDE-Ge represents Bis (4-methoxybenzoyl) diethylgermanium; DBDE-Ge represents dibenzoyldiethylgermanium; TEB-Ge represents tetrakis (2-ethylbenzoyl)-germanium; TTMB-Sn represents tetrakis (2,4,6-trimethylbenzoyl) stannane; MEK represents methylethyl ketone; PBS represents a phosphate-buffered saline which has a pH of 7.2+0.2 at 25° C. and contains about 0.79 wt. % NaCl, about 0.044 wt. % NaH₂PO₄·H₂O, about 0.388 wt. % Na₂HPO₄·2H₂O, and 98.78% water; wt. % represents weight percent; “G1” represents a di-methacryloyloxypropyl-terminated polysiloxane (Mn ˜7.5-8.1K g/mol, OH content ˜1.25-1.55 mmol/g) of formula (A) shown below.

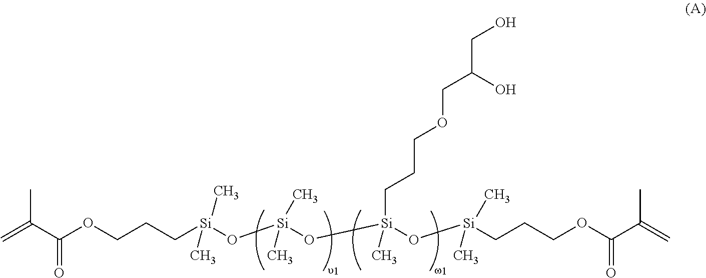

### Example 2

### Preparation of Polymerizable Composition

A lens formulations (polymerizable composition) is prepared to have compositions (in unit parts) as following: D9 (33); G4 (10); NVP (46); MMA (10); TEGDMA (0.65); Norbloc (1.5); UV28 (0.40); VAZO 64 (0.5); RB247 (0.01); & TAA (10).

The formulations are prepared by adding listed components in their targeted amounts into a clean bottle, with a stir bar to mix at 600 rpm for 30 minutes at room temperature. After all the solid is dissolved, a filtration of the formulation is carried out by using 2.7 μm glass-microfiber-filter.

### Cast-Molded SiHy Contact Lenses

A lens formulation is purged with nitrogen at room temperature for 30 to 35 minutes. The N2-purged lens formulation is introduced into polypropylene molds and thermally cured in an oven under the following curing conditions: ramping from room temperature to 55° C. and then holding at 55° C. for about 30 minutes; ramping from 55° C. to 80° C. and holding at 80° C. for about 2 hours; and ramping from 80° C. to 100° C. and holding at 100° C. for about 30 minutes.

Lens molds are opened manually and lenses are pushed out of the mold using an arbor press.

After de-molding, the SiHy contact lenses are soaked in an aqueous solution of 0.2% Tinopal CBS-X (Disodium-4,4′-bis(2-sulfonatostyryl)biphenyl) (0.2%) overnight, extracted, packaged in saline solution, and autoclaved. Two extraction media are used: isopropanol (IPA) and deionized water (DI). Where IPA is used, lenses are extracted in 100% IPA for 3 hours, followed by 50/50 IPA/DI for 30 minutes, DI for 1 hour before packaging. Where deionized water (DI) is used, lenses are extracted in DI before packaging.

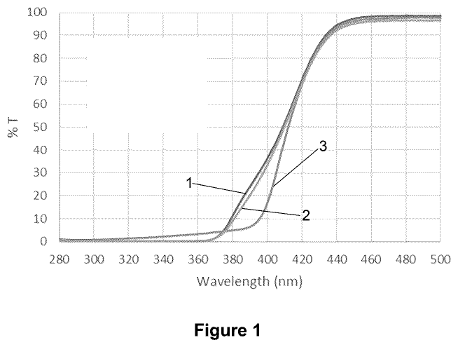

Lenses treated with CBS-X and DI-extracted (sample M-T-DI) has a more blue-ish appearance, as shown by having a reduced b* value compared to control lenses (i.e., not soaked in CBS-X solution). There is a reduction in b* of (4.85-3.92)/4.85=19%, indicating that the treated lens is shifting its color towards blue. It is also shown that the HEVL blocking performance, as measured by the average % T in 380˜450 nm, is preserved, if not slightly improved with the addition of the brightener (Table 1 & FIG. 1). It is also shown that due to the non-reactive nature of the CBS-x dyes, most of the brighteners can be washed out significantly during the alcohol extraction process.

TABLE 1

| Lens | CBS-X | | CIE L*a*b* | | | HEVL |
|---|---|---|---|---|---|---|
| Sample | treated | Extraction | L* | a* | b* | % T |
| M-C | No | IPA | 83.08 | −7.88 | 4.85 | 59.26 |
| M-T-IPA | Yes | IPA | 82.79 | −7.84 | 4.86 | 57.06 |
| M-T-DI | Yes | DI | 82.96 | −7.22 | 3.95 | 51.83 |

### Example 3

### Preparation of Polymerizable Composition

A lens formulations (polymerizable composition) is prepared to have compositions (in unit parts) as following: D9 (33); G4 (10); NVP (46); MMA (10); EGMA (0.1); TEGDMA (0.65); Norbloc (1.5); UV28 (0.40); VAZO 64 (0.5); RB247 (0.01); & TAA (10).

The formulations are prepared by adding listed components in their targeted amounts into a clean bottle, with a stir bar to mix at 600 rpm for 30 minutes at room temperature. After all the solid is dissolved, a filtration of the formulation is carried out by using 2.7 μm glass-microfiber-filter.

### Cast-Molded SiHy Contact Lenses

A lens formulation is purged with nitrogen at room temperature for 30 to 35 minutes. The N2-purged lens formulation is introduced into polypropylene molds and thermally cured in an oven under the following curing conditions: ramping from room temperature to 55° C. and then holding at 55° C. for about 30 minutes; ramping from 55° C. to 80° C. and holding at 80° C. for about 2 hours; and ramping from 80° C. to 100° C. and holding at 100° C. for about 30 minutes.

Lens molds are opened manually and lenses are pushed out of the mold using an arbor press.

After de-molding, the SiHy contact lenses are soaked in an aqueous solution of 0.2% Tinopal CBS-X (Disodium-4,4′-bis(2-sulfonatostyryl)biphenyl) (0.2%) overnight, extracted with DI, packaged in saline solution, and autoclaved.

Lenses treated with CBS-X and DI-extracted (sample P-T-DI) has a more blue-ish appearance, as shown by having a reduction in b* of (5.39-3.48)/5.39=35% (compared to control lenses P-C which are not soaked in CBS-X solution). The optical-brightener-treated lens is shifting its color towards blue. It is also found that the HEVL blocking performance, as measured by the average % T in 380˜450 nm, is preserved (Table 2). It is also shown that due to the non-reactive nature of the CBS-x dyes, most of the brighteners can be washed out significantly during the alcohol extraction process.

TABLE 2

| Lens | CBS-X | CIE L*a*b* | | | HEVL | % T avg |
|---|---|---|---|---|---|---|
| Sample | treated | L* | a* | b* | % T | 380~450 nm |
| P-C | No | 83.08 | −7.88 | 4.85 | 59.26 | 66.88 |
| P-T-DI | Yes | 82.96 | −7.22 | 3.95 | 51.83 | 61.75 |

All the publications and patents which have been cited herein above are hereby incorporated by reference in their entireties.

What is claimed is:

1. A UV/HEVL-filtering silicone hydrogel contact lens, comprising a bulk silicone hydrogel material that comprises:
(1) repeating units of at least one hydrophilic vinylic monomer;
(2) repeating units of at least one silicone-containing vinylic monomer and/or at least one polysiloxane vinylic crosslinker;
(3) repeating units of at least one UV-absorbing vinylic monomer;
(4) repeating units of at least one polymerizable HEVL-absorbing compound capable of absorbing HEVL between 380 nm and 450 nm;
(5) at least one blue-tinting agent distributed within the bulk silicone hydrogel material; and
(5) at least one optical brightener distributed within the bulk silicone hydrogel material in an amount for provide the HEVL-filtering contact lens with a reduced b* value without decreasing HEVL % T of the HEVL-filtering contact lens,
wherein the HEVL-filtering contact lens in fully hydrated state has a UVA % T of less than 5%, UVB % T of about 1% or less, a HEVL % T of about 65% or less, and an averaged % transmission of at least 90% between 450 nm and 700 nm.

2. The UV/HEVL-filtering silicone hydrogel contact lens of claim 1, wherein the UV/HEVL-filtering silicone hydrogel contact lens in fully hydrated has a reduction in b* value of at least 10% relative to a control UV-HEVL-filtering silicone hydrogel contact lens free of optical brightener.

3. The UV/HEVL-filtering silicone hydrogel contact lens of claim 2, wherein said at least one UV-absorbing vinylic monomer comprises 2-(2′-hydroxy-5′-vinylphenyl)-2H-benzotriazole, 2-(2′-hydroxy-5′-methacryloxyphenyl)-2H-benzotriazole, 2-(2′-hydroxy-5′-acryloxyphenyl)-2H-benzotriazole, 2-[2′-hydroxy-5′-(2-methacryloxyethyl)phenyl)]-2H-benzotriazole, 2-[2′-hydroxy-5′-(2-acryloxyethyl)phenyl)]-2H-benzotriazole, 2-(2′-hydroxy-5′-methacryloxy-propyl-phenyl)-2H-benzotriazole, 2-(2′-hydroxy-5′-acryloxypropylphenyl)-2H-benzotriazole, or combinations thereof.

4. The UV/HEVL-filtering silicone hydrogel contact lens of claim 2, wherein said at least one polymerizable HEVL-absorbing compound comprises: (i) 2-{2′-Hydroxy-3′-tert-butyl-5′-[3′-methacryloyloxypropoxy]phenyl}-5-chloro-2H-benzotriazole, 2-[2′-Hydroxy-3′-tert-butyl-5′-(3′-acryloyloxypropoxy)phenyl]-5-trifluoromethyl-2H-benzotriazole, or combinations thereof; and/or (ii) at least one polymerizable Cu(II)-porphyrin derivative.

5. The UV/HEVL-filtering silicone hydrogel contact lens of claim 2, wherein the bulk silicone hydrogel material in dried state comprises from about 1.2% to about 3.5% by weight of all components (3), (4) and (5), wherein weight ratio of component (4) over component (5) is from about 0.25 to about 2.5.

6. The UV/HEVL-filtering silicone hydrogel contact lens of claim 2, wherein the bulk silicone hydrogel material comprises: Cu(II)-phthalocyanine pigment particles distributed therein; repeating units of at least one polymerizable blue dye; or combinations thereof.

7. The UV/HEVL-filtering silicone hydrogel contact lens of claim 2, wherein the bulk silicone hydrogel material comprises repeating units of: 1,4-bis(4-(2-methacryloxyethyl)-phenylamino)anthraquinone; 1,4-bis((2-methacryloxy-ethyl)amino)anthraquinone; or combinations thereof.

8. The UV/HEVL-filtering silicone hydrogel contact lens of claim 2, wherein said at least one optical brightener comprises a bis(benzoxazol-2-yl) derivative, a distyrylbenzene, a distyrylbiphenyl derivative, a divinylstilbene, a triazinylaminostilbene, a stilbenyl-2H-triazole, a benzofuran, a benzimidazole, a diphenyl pyrazoline, a coumarin, a naphthalimide, or combinations thereof.

9. The UV/HEVL-filtering silicone hydrogel contact lens of claim 2, wherein said at least one optical brightener comprises 4,4′-diamino-2,2′-stilbenedisulfonic acid, 2,2′-(1,4-naphthalenediyl)bisbenzoxazole, 2,5-thiophenediylbis(5-tert-butyl-1,3-benzoxazole), 4,4′-bis(2-benzoxazolyl) stilbene, disodium-4,4′-bis(2-sulfonatostyryl)-biphenyl, or combinations thereof.

10. The UV/HEVL-filtering silicone hydrogel contact lens of claim 8, wherein said at least one hydrophilic vinylic monomer comprises hydroxyethyl (meth)acrylate, glycerol (meth)acrylate, N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, di(ethylene glycol) (meth)acrylate, tri(ethylene glycol) (meth)acrylate, tetra(ethylene glycol) (meth)acrylate, poly(ethylene glycol) (meth)acrylate, N,N-dimethyl (meth)acrylamide, (meth)acrylamide, N-ethyl (meth)acrylamide, N,N-diethyl (meth)acrylamide, N-propyl (meth)acrylamide, N-isopropyl (meth)acrylamide, N-3-methoxy-propyl (meth)acrylamide, N-vinylpyrrolidone, N-vinyl-N-methyl acetamide, N-vinyl-N-ethyl acetamide, N-vinyl-N-ethyl formamide, 1-methyl-3-methylene-2-pyrrolidone, 1-methyl-5-methylene-2-pyrrolidone, 1-methyl-3-methylene-2-pyrrolidone, N-2-hydroxyethyl vinyl carbamate, N-carboxyvinyl-β-alanine (VINAL), N-carboxyvinyl-α-alanine, a phosphorylcholine-containing vinylic monomer, (meth)acrylic acid, vinyl alcohol, ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, poly(ethylene glycol) methyl ether, or combinations thereof.

11. The UV/HEVL-filtering silicone hydrogel contact lens of claim 8, wherein said at least one polysiloxane vinylic crosslinker comprises a di-(meth)acryloyloxy-terminated polysiloxane vinylic crosslinker having dimethylsiloxane units and hydrophilized siloxane units each having one methyl substituent and one monovalent C₄-C₄₀ organic radical substituent having 2 to 6 hydroxyl groups.

12. The UV/HEVL-filtering silicone hydrogel contact lens of claim 8, wherein the UV/HEVL-filtering silicone hydrogel contact lens has: an oxygen permeability of at least 60 barrers (at about 35° C.); an elastic modulus of about 2.0 MPa or less (at a temperature of from 22° C. to 28° C.); a water content of from about 15% to about 70% (at a temperature of from 22° C. to 28° C.); or combinations thereof, when being fully hydrated.

13. A method for producing HEVL-filtering silicone hydrogel contact lenses, comprising the steps of:
(1) obtaining preformed HEVL-filtering silicone hydrogel contact lenses each free of optical brightener;
(2) drying the preformed HEVL-filtering silicone hydrogel contact lenses;
(3) soaking the preformed HEVL-silicone hydrogel contact lenses in dry state obtained step (2) in a solution comprising at least one optical brightener for sufficient long to allow the optical brightener to penetrate into and distribute in each of the preformed HEVL-filtering silicone hydrogel contact lenses;
(4) washing the preformed HEVL-filtering silicone hydrogel contact lenses having the optical brightener distributed therein with water or an aqueous solution to remove excess optical brightener while retaining the optical brightener in an amount for provide the HEVL-filtering contact lens with a reduced b* value without decreasing HEVL % T of the HEVL-filtering contact lens; and
(5) packaging and autoclaving the preformed HEVL-filtering silicone hydrogel contact lenses obtained in step (4) in a packaging solution in a sealed lens package,
wherein each of the HEVL-filtering silicone hydrogel contact lenses in fully hydrated state has a UVA % T of less than 5%, UVB % T of about 1% or less, a HEVL % T of about 65% or less, and an averaged % transmission of at least 90% between 450 nm and 700 nm and comprises a bulk silicone hydrogel material that comprises the optical brightener distributed therein and repeating units of (a) at least one hydrophilic vinylic monomer, (b) at least one siloxane-containing vinylic monomer and/or at least one polysiloxane vinylic crosslinker, (c) at least one UV-absorbing vinylic monomer, (d) at least one polymerizable HEVL-absorbing compound capable of absorbing HEVL between 380 nm and 450 nm, and (e) at least blue-tinting agent.

14. The method of claim 13, wherein said at least one optical brightener comprises a bis(benzoxazol-2-yl) derivative, a distyrylbenzene, a distyrylbiphenyl derivative, a divinylstilbene, a triazinylaminostilbene, a stilbenyl-2H-triazole, a benzofuran, a benzimidazole, a diphenyl pyrazoline, a coumarin, a naphthalimide, or combinations thereof.

15. The method of claim 13, wherein said at least one optical brightener comprises 4,4′-diamino-2,2′-stilbenedisulfonic acid, 2,2′-(1,4-naphthalenediyl)bisbenzoxazole, 2,5-thiophenediylbis(5-tert-butyl-1,3-benzoxazole), 4,4′-bis(2-benzoxazolyl) stilbene, disodium-4,4′-bis(2-sulfonatostyryl)-biphenyl, or combinations thereof.

16. The method of claim 14, wherein said at least one blue-tinting agent comprises Cu(II)-phthalocyanine pigment particles and/or at least one polymerizable blue dye.

17. The method of claim 16, wherein said at least one UV-absorbing vinylic monomer comprises 2-(2′-hydroxy-5′-vinylphenyl)-2H-benzotriazole, 2-(2′-hydroxy-5′-methacryloxyphenyl)-2H-benzotriazole, 2-(2′-hydroxy-5′-acryloyloxyphenyl)-2H-benzotriazole, 2-[2′-hydroxy-5′-(2-methacryloxyethyl)phenyl)]-2H-benzotriazole (Norbloc), 2-[2′-hydroxy-5′-(2-acryloxyethyl)phenyl)]-2H-benzotriazole, 2-(2′-hydroxy-5′-methacryloxypropyl-phenyl)-2H-benzotriazole, 2-(2′-hydroxy-5′-acryloxypropylphenyl)-2H-benzotriazole, or combinations thereof, wherein said at least one polymerizable HEVL-absorbing compound comprises: (i) 2-{2′-Hydroxy-3′-tert-butyl-5′-[3′-methacryloxypropoxy]-phenyl}-5-chloro-2H-benzotriazole, 2-[2′-Hydroxy-3′-tert-butyl-5′-(3′-acryloxypropoxy)-phenyl]-5-trifluoromethyl-2H-benzotriazole, or combinations thereof; (ii) at least one polymerizable HEVL-absorbing compound comprises at least one polymerizable Cu(II)-porphyrin derivative; or (iii) combinations thereof.

18. The method of claim 17, wherein said at least one free-radical initiator is a thermal initiator, wherein the polymerizable composition is cured thermally.

19. The method of claim 17, wherein said at least one free-radical initiator is a visible light photoinitiator, wherein the polymerizable composition is cured with a visible light having a wavelength of from 450 nm to 510 nm.

20. A method for producing HEVL-filtering silicone hydrogel contact lenses, comprising the steps of:
(1) introducing a polymerizable composition into a mold, wherein the polymerizable composition comprises (a) at least one hydrophilic vinylic monomer, (b) at least one siloxane-containing vinylic monomer and/or at least one polysiloxane vinylic crosslinker, (c) at least one UV-absorbing vinylic monomer, (d) at least one polymerizable HEVL-absorbing compound capable of absorbing HEVL between 380 nm and 450 nm, (e) at least blue-tinting agent; (f) at least one reactive optical brightener present in an amount for provide the HEVL-filtering contact lens with a reduced b* value without decreasing HEVL % T of the HEVL-filtering contact lens, and (g) from about 0.2% to about 1.5% by weight of at least one free-radical initiator, wherein the mold comprises a female mold halve having a first molding surface and a male mold half having a second molding surface, wherein the mold halves are configured to receive each other such that a lens-forming cavity is formed between the first molding surface and the second molding surface;
(2) curing the polymerizable composition in the mold to form a UV/HEVL-filtering silicone hydrogel contact lens precursor;
(3) removing the UV/HEVL-filtering silicone hydrogel contact lens precursor from the mold; and
(4) subjecting the UV/HEVL-filtering silicone hydrogel contact lens precursor to one or more post-molding processes selected from the group consisting of extraction, hydration, surface treatment, packaging, sterilization, and combinations thereof,
wherein each of the HEVL-filtering silicone hydrogel contact lenses in fully hydrated state has a UVA % T of less than 5%, UVB % T of about 1% or less, a HEVL % T of about 65% or less, and an averaged % transmission of at least 90% between 450 nm and 700 nm.
